(19) United States
(12) Patent Application Publication
(10) Pub. No.: US 2011/0156996 A1
(43) Pub. Date: Jun. 30, 2011

(54) IMAGE INPUT/OUTPUT DEVICE

(75) Inventor: Tomoo Izumi, Toyonaka-shi (JP)

(73) Assignee: Konica Minolta Holdings, Inc., Tokyo (JP)

(21) Appl. No.: 13/060,120

(22) PCT Filed: Sep. 2, 2009
(86) PCT No.: PCT/JP2009/065296

§ 371 Date: Feb. 22, 2011

(30) Foreign Application Priority Data
Sep. 5, 2008 (JP) 2008-228593

(51) Int. Cl. G09G 3/36

(52) U.S. Cl. 345/92

(57) ABSTRACT

An image input/output device is provided that can instantaneously write an image by applying an optical pattern and that can acquire information on the written image as image data. This image input/output device includes a TFT (10); a photoelectric conversion portion (20) including a photoelectric conversion layer (21), a photoelectric conversion pixel electrode (22) and a photoelectric conversion common electrode (23); a display portion (30) including a display layer (33), a display pixel electrode (31) and a display common electrode (32); and a charge sensing amplifier (71) that amplifies an output signal from the photoelectric conversion portion (20). The display pixel electrode (31) and the photoelectric conversion pixel electrode (22) are electrically connected to each other; the TFT 10 can switch between the display pixel electrode (31) and the photoelectric conversion pixel electrode (22) electrically connected to each other and the charge sensing amplifier (71); and a display common electrode (32) can switch between a constant potential state and a floated state.

### TECHNICAL FIELD

The present invention relates to an image input/output device, and more particularly to an image input/output device that applies light to write information.

### BACKGROUND ART

Conventionally, there are known image input/output devices that apply light to write information (for example, see patent document 1).

Patent document 1 discloses a direct contact image sensor in which an optical sensor and a light source are so arranged on a base substrate as to be on the same plane. In this direct contact image sensor, the light source, for example, is formed with thin-film light emission layers composed of organic electroluminescence (EL) elements. A thin plate glass is arranged on the optical sensor and the light source, and a document is placed on this thin plate glass. In the direct contact image sensor configured as described above and disclosed in patent document 1, light from the light source is reflected off the document, and the reflected light is photoelectrically converted by the optical sensor. Then, image signals corresponding to a contrast image on the document are acquired as image data. Thereafter, based on the acquired image data, the image is scanned and written, and the acquired image is displayed on a display screen.

However, since the conventional image sensor disclosed in patent document 1 described above needs to scan and write the image based on the acquired image data in order to display the image, it disadvantageously takes a long time to display the image. Moreover, since the conventional image sensor disclosed in patent document 1 described above needs to scan and write the image, it is disadvantageously necessary to additionally provide a driver, a power supply and the like for the scanning and writing.

On the other hand, conventionally, there is proposed an optical address spacial light modulation element that can instantaneously write an image by applying an optical pattern (for example, see patent document 2). This optical address spacial light modulation element has a structure in which a display layer composed of cholesteric liquid crystal having a memory characteristic and the like, a light absorbent layer and a photoconductive layer are sandwiched within a substrate having a pair of transparent electrodes. In the optical address spacial light modulation element having the above structure, pattern light representing an image is applied to the photoconductive layer with a bias voltage applied between the transparent electrodes, and thus part of the photoconductive layer where the light is shone is lowered in impedance and a strong electric field is applied to the display layer. In this way, after power is applied, the liquid crystal is maintained to reflect external light. On the other hand, in the part where the light is not shone, the impedance of the photoconductive layer is kept high, and thus only a weak electric field is applied to the side of the display layer. Hence, after voltage is applied, the liquid crystal is maintained to transmit light. The difference between the reflection state and the transmissive state allows the display of an image. That is, the optical pattern is applied, and simultaneously the image is displayed on the display layer.

Since the optical address spacial light modulation element of patent document 2 described above does not need to scan and write an image due to the configuration described above, it is unnecessary to additionally provide a driver, a power supply and the like for the scanning and writing.
Patent document 1: JP-A-H08-55974
Patent document 2: JP-A-2007-114472

### DISCLOSURE OF THE INVENTION

### Problems to be Solved by the Invention

However, although, in the conventional optical address spacial light modulation element proposed in patent document 2 described above, it is possible to instantaneously write an image by applying an optical pattern, it is disadvantageously impossible to acquire information on the written image as image data.

The present invention is designed to overcome the disadvantage described above, and has as an object to provide an image input/output device that can instantaneously write an image by applying an optical pattern and that can acquire information on the written image as image data.

### Means for Solving the Problem

To achieve the above object, according to one aspect of the present invention, there is provided an image input/output device including: a switching element formed on a substrate; a display portion that is formed on the substrate and that includes a display layer and a first pixel electrode and a first common electrode, the first pixel electrode and the first common electrode sandwiching the display layer; a photoelectric conversion portion that is formed on the substrate and that includes a photoelectric conversion layer and a second pixel electrode and a second common electrode, the second pixel electrode and the second common electrode sandwiching the photoelectric conversion layer; and an amplification portion that amplifies an output signal from the photoelectric conversion portion. In the image input/output device, the first pixel electrode of the display portion and the second pixel electrode of the photoelectric conversion portion are electrically connected to each other, the switching element can switch, between an “on” state and an “off” state, a connection between the first pixel electrode and the second pixel electrode electrically connected to each other and the amplification portion, and the first common electrode can switch between a constant potential state and a floated state.

In the image input/output device of the above aspect, as described above, the first pixel electrode of the display portion and the second pixel electrode of the photoelectric conversion portion are electrically connected to each other and the first common electrode is switched to the constant potential state, and thus it is possible to apply a predetermined potential (voltage) to the display layer and the photoelectric conversion layer. When, in this state, the pattern light is applied to the photoelectric conversion layer, the potential (voltage) applied to the photoelectric conversion layer is varied according to the amount of light applied. Then, as the potential (voltage) applied to the photoelectric conversion layer is varied, the potential (voltage) applied to the display layer is varied. Thus, it is possible to vary the display state of the display portion according to the amount of light applied. In this way, it is possible to display an image on the display portion. Consequently, with the configuration described above, it is possible to instantaneously write an image by applying an optical pattern. For example, it is possible to instantaneously copy an optical image or the like on a light-emitting display screen.

In the image input/output device of the above aspect, since the above configuration is employed and thus charge can be stored in the photoelectric conversion layer according to the display image, it is possible to acquire information on the written image as image data by reading the charge stored in the photoelectric conversion layer.

In the image input/output device of the above aspect, the switching element, the photoelectric conversion portion and the display portion may be formed on the same substrate, and at least one of the switching element, the photoelectric conversion portion and the display portion may be formed on a different substrate. For example, the switching element and the photoelectric conversion portion may be formed on the same substrate, and the display portion may be formed on a substrate different from the substrate on which the switching element and the photoelectric conversion portion are formed. In this case, the display portion can be separated.

In the image input/output device of the above aspect, an image corresponding to an exposure pattern can be displayed on the display portion by exposure. Even with this configuration, it is possible to instantaneously copy, for example, an optical image on a light-emitting display screen.

The image input/output device of the above aspect can be configured in such a way that the first common electrode is brought into the constant potential state such that the display layer of the display portion is brought into a substantially transmissive state, and exposure is performed with the display layer in the substantially transmissive state such that an image corresponding to an exposure pattern is displayed on the display portion.

The image input/output device in which the image is displayed by the exposure can be configured in such a way that the first common electrode and the switching element are brought into the floated state and the “on” state, respectively, after the exposure such that information on the image displayed on the display portion is acquired as image data. In other words, with the above configuration, it is possible to feed the charge (the charge corresponding to the display image) stored in the photoelectric conversion layer to the amplification portion by turning on the switching element. Thus, it is possible to acquire information on the written image as image data.

In this case, a recording portion that records the acquired image data may be further included.

Preferably, in the image input/output device of the above aspect, a predetermined potential is applied to the photoelectric conversion portion to reset the photoelectric conversion portion, and a difference between a potential applied to the first common electrode and an applied potential for resetting the photoelectric conversion portion is less than a potential difference that is necessary to turn a display state of the display portion from an “on” state to an “off” state. With this configuration, since variations in image density can be displayed between a minute exposure amount and the vicinity of a saturated exposure amount, it is possible to display an image on the display portion with satisfactory contrast.

Preferably, in the image input/output device of the above aspect, a predetermined potential is applied to the photoelectric conversion portion to reset the photoelectric conversion portion, and a difference between a potential applied to the first common electrode and an applied potential for resetting the photoelectric conversion portion is equal to or more than a potential difference that is necessary to turn a display state of the display portion from an “on” state to an “off” state. With this configuration, it is possible to set the contrast of the display portion at the highest contrast.

Preferably, in the image input/output device of the above aspect, any one of a light absorbent layer, a light reflective layer, a semi-absorbent, semi-transmissive layer and a semi-reflective, semi-transmissive layer is included, and, when seen from an observation side, any one of the light absorbent layer, the light reflective layer, the semi-absorbent, semi-transmissive layer and the semi-reflective, semi-transmissive layer is formed on the side of a back surface of the display layer of the display portion.

Preferably, in the image input/output device of the above aspect, the display portion includes a display element having a memory characteristic. With this configuration, it is possible to maintain an image displayed on the display portion without power being supplied by bringing the first common electrode in the floated state.

In this case, the display element having a memory characteristic preferably includes chiral nematic liquid crystal. With this configuration, it is possible to easily maintain an image displayed on the display portion without power being supplied.

Preferably, in the configuration in which the display portion includes the display element having a memory characteristic, the display element having a memory characteristic may be an electrochemical reaction display element. Examples of the electrochemical reaction display element include an ECD (electrochromic display) element utilizing the color change of an electrochromic material resulting from an oxidation-reduction reaction and an ED (electrodeposition) display element utilizing the dissolution and precipitation of a metal or a metallic salt.

In the image input/output device of the above aspect, the photoelectric conversion layer and the display layer can be sequentially formed on the substrate from the side of the substrate.

In the image input/output device of the above aspect, the display layer and the photoelectric conversion layer can be sequentially formed on the substrate from the side of the substrate.

In the image input/output device of the above aspect, the image corresponding to the exposure pattern may be displayed on the display portion by performing the exposure from a side of a back surface of the substrate.

In the image input/output device of the above aspect, the image corresponding to the exposure pattern can be displayed on the display portion by performing the exposure from a side of a front surface of the substrate.

In the image input/output device of the above aspect, the switching element can be formed with a thin film transistor element.

In the configuration in which the switching element is formed with the thin film transistor element, the second pixel electrode may be arranged on a side of the substrate with respect to the photoelectric conversion layer and the second common electrode may be arranged on a side opposite the substrate with respect to the photoelectric conversion layer such that the thin film transistor element and the photoelectric conversion portion are configured in a bias top structure.

In the configuration in which the switching element is formed with the thin film transistor element, the second pixel electrode can be arranged on a side opposite the substrate with respect to the photoelectric conversion layer and the second common electrode can be arranged on a side of the substrate with respect to the photoelectric conversion layer such that the thin film transistor element and the photoelectric conversion portion are configured in a bias bottom structure.

In the configuration in which the switching element is formed with the thin film transistor element, the photoelectric conversion portion can be formed above the thin film transistor element such that the thin film transistor element and the photoelectric conversion portion are configured in a stack structure.

In the configuration in which the switching element is formed with the thin film transistor element, at least one of the thin film transistor element and the photoelectric conversion layer is preferably formed of organic semiconductor. With this configuration, it is possible to easily form at least one of the thin film transistor element and the photoelectric conversion layer as compared with an inorganic semiconductor. When both of the thin film transistor element and the photoelectric conversion layer are formed with organic semiconductor, it is possible to obtain an image input/output device that is lightweight and thin and that can be bent.

In the image input/output device of the above aspect, the amplification portion is preferably a charge sensing amplifier including an operational amplifier and a capacitor.

### Advantages of the Invention

As described above, according to the present invention, it is possible to easily obtain an image input/output device that can instantaneously write an image by applying an optical pattern and that can acquire information on the written image as image data.

### BRIEF DESCRIPTION OF DRAWINGS

FIG. 1 A diagram showing the circuit configuration of an image input/output device according to a first embodiment of the present invention;

FIG. 2 A diagram showing the circuit configuration of the image input/output device according to the first embodiment of the present invention;

FIG. 3 A diagram showing part of the circuit configuration of the image input/output device according to the first embodiment of the present invention;

FIG. 4 A plan view showing part of a pixel array portion of the image input/output device according to the first embodiment of the present invention;

FIG. 5 A cross-sectional view taken along line A-A of FIG. 4;

FIG. 6 A schematic cross-sectional view of the pixel array portion of the image input/output device according to the first embodiment of the present invention;

FIG. 7 A diagram schematically showing the configuration of the pixel array portion of the image input/output device according to the first embodiment of the present invention;

FIG. 8 A schematic diagram showing a display element of the image input/output device according to the first embodiment of the present invention;

FIG. 9 A diagram illustrating the refractive index of a liquid crystal molecule;

FIG. 10 A diagram showing the characteristic of the display element shown in FIG. 8;

FIG. 11 A diagram illustrating the display principle of the display element shown in FIG. 8;

FIG. 12 A timing chart illustrating the operation of the image input/output device according to the first embodiment of the present invention;

FIG. 13 A cross-sectional view illustrating a method of manufacturing an array substrate of the image input/output device according to the first embodiment of the present invention;

FIG. 14 A cross-sectional view illustrating the method of manufacturing the array substrate of the image input/output device according to the first embodiment of the present invention;

FIG. 15 A cross-sectional view illustrating the method of manufacturing the array substrate of the image input/output device according to the first embodiment of the present invention;

FIG. 16 A cross-sectional view illustrating the method of manufacturing the array substrate of the image input/output device according to the first embodiment of the present invention;

FIG. 17 A cross-sectional view illustrating the method of manufacturing the array substrate of the image input/output device according to the first embodiment of the present invention;

FIG. 18 A cross-sectional view illustrating the method of manufacturing the array substrate of the image input/output device according to the first embodiment of the present invention;

FIG. 19 A cross-sectional view illustrating the method of manufacturing the array substrate of the image input/output device according to the first embodiment of the present invention;

FIG. 20 A cross-sectional view illustrating the method of manufacturing the array substrate of the image input/output device according to the first embodiment of the present invention;

FIG. 21 A schematic diagram showing a display element of an image input/output device of a fourth embodiment of the present invention;

FIG. 22 A diagram showing the characteristic of the display element shown in FIG. 21;

FIG. 23 A diagram illustrating the display principle of the display element shown in FIG. 21;

FIG. 24 A timing chart illustrating the operation of the image input/output device according to the fourth embodiment of the present invention;

FIG. 25 A diagram illustrating the display principle of a display element of an image input/output device according to a fifth embodiment of the present invention

FIG. 26 A timing chart illustrating the operation of the image input/output device according to the fifth embodiment of the present invention;

FIG. 27 A diagram illustrating a potential applied to a photoelectric conversion portion and a display portion;

FIG. 28 A diagram schematically showing the configuration of a pixel array portion of an image input/output device according to a sixth embodiment of the present invention;

FIG. 29 A diagram schematically showing the configuration of a pixel array portion of an image input/output device according to a first variation of the sixth embodiment;

FIG. 30 A diagram schematically showing the configuration of a pixel array portion of an image input/output device according to a second variation of the sixth embodiment;

FIG. 31 A diagram schematically showing the configuration of a pixel array portion of an image input/output device according to a third variation of the sixth embodiment;

FIG. 32 A diagram schematically showing the configuration of a pixel array portion of an image input/output device according to a seventh embodiment of the present invention;

FIG. 33 A diagram schematically showing the configuration of a pixel array portion of an image input/output device according to a first variation of the seventh embodiment;

FIG. 34 A diagram schematically showing the configuration of a pixel array portion of an image input/output device according to a second variation of the seventh embodiment;

FIG. 35 A diagram schematically showing the configuration of a pixel array portion of an image input/output device according to a third variation of the seventh embodiment;

FIG. 36 A diagram schematically showing the configuration of a pixel array portion of an image input/output device according to a fourth variation of the seventh embodiment;

FIG. 37 A plan view showing part of a pixel array portion of an image input/output device according to an eighth embodiment;

FIG. 38 A cross-sectional view taken along line B-B of FIG. 37;

FIG. 39 A cross-sectional view showing part of a pixel array portion of an image input/output device according to a ninth embodiment;

FIG. 40 A cross-sectional view showing part of a pixel array portion of an image input/output device according to a tenth embodiment;

FIG. 41 A diagram (diagram showing a basic skeleton of a conductive polymer compound) showing one specific example of materials constituting a photoelectric conversion portion of the image input/output device according to the tenth embodiment;

FIG. 42 A diagram (diagram showing a specific example (part 1) of a π-conjugated polymer compound) showing one specific example of materials constituting the photoelectric conversion portion of the image input/output device according to the tenth embodiment;

FIG. 43 A diagram (diagram showing a specific example (part 2) of the π-conjugated polymer compound) showing one specific example of materials constituting the photoelectric conversion portion of the image input/output device according to the tenth embodiment;

FIG. 44 A diagram (diagram showing a specific example (part 3) of the π-conjugated polymer compound) showing one specific example of materials constituting the photoelectric conversion portion of the image input/output device according to the tenth embodiment;

FIG. 45 A diagram (diagram showing a specific example (part 4) of the π-conjugated polymer compound) showing one specific example of materials constituting the photoelectric conversion portion of the image input/output device according to the tenth embodiment;

FIG. 46 A diagram (diagram showing a specific example (part 1) of a conductive polymer compound other than a π-conjugated system) showing one specific example of materials constituting the photoelectric conversion portion of the image input/output device according to the tenth embodiment;

FIG. 47 A diagram (diagram showing a specific example (part 2) of the conductive polymer compound other than a π-conjugated system) showing one specific example of materials constituting the photoelectric conversion portion of the image input/output device according to the tenth embodiment.

### BEST MODE FOR CARRYING OUT THE INVENTION

Embodiments of the present invention will be described in detail below with reference to the accompanying drawings.

### First Embodiment

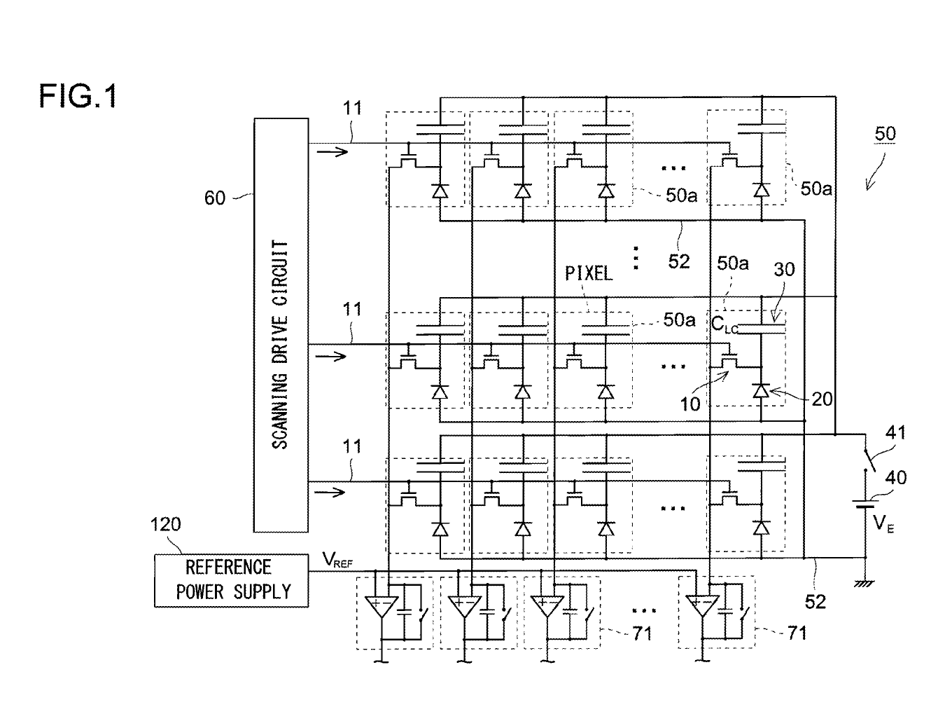

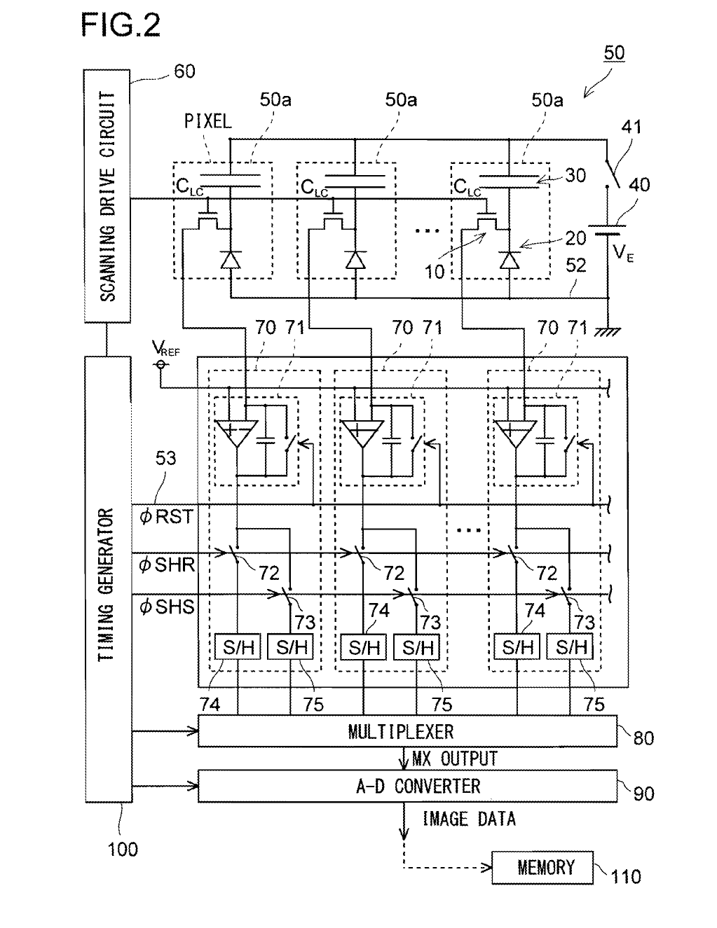

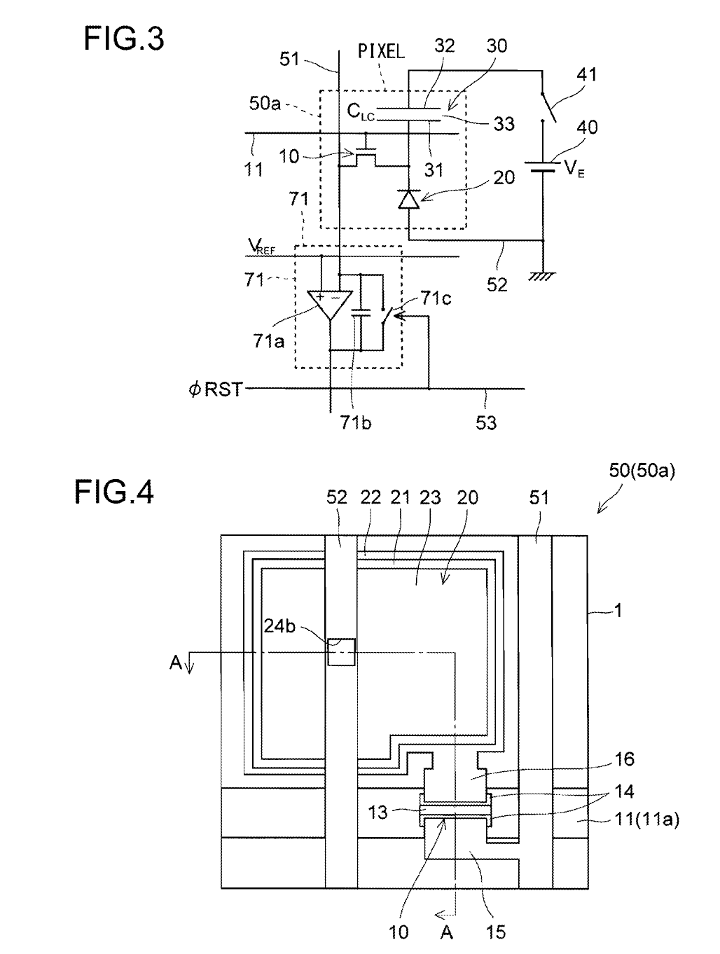

FIGS. 1 and 2 are diagrams showing the circuit configuration of an image input/output device according to a first embodiment of the present invention. FIG. 3 is a diagram showing part of the circuit configuration of the image input/output device according to the first embodiment of the present invention. FIGS. 1 and 2 show the overall configuration of the image input/output device according to the first embodiment of the present invention. The configuration of the image input/output device according to the first embodiment of the present invention will first be described with reference to FIGS. 1 to 3.

As shown in FIGS. 1 and 2, the image input/output device of the first embodiment includes: a pixel array portion 50 that includes a plurality of pixels 50a arranged in a two-dimensional matrix (in a matrix); a scanning drive circuit 60 that scans the pixels 50a of the pixel array portion 50 in a column direction; column output circuits 70 (see FIG. 2) that hold electrical signals output from the pixels 50a of the pixel array portion 50; a multiplexer 80 (see FIG. 2) that converts the electrical signals held in the column output circuits 70 into serial electrical signals for each column; an A-D converter 90 (see FIG. 2) that converts into digital data the electrical signals fed from the multiplexer 80; a timing generator 100 (see FIG. 2); and a memory 110 (see FIG. 2) that records the digital data. The memory 110 is an example of a “recording portion” of the present invention.

The pixel array portion 50 includes: a plurality of thin film transistor elements (TFTs) 10; a plurality of photoelectric conversion portions (photodiodes) 20 that photoelectrically convert incoming (applied) light; and display portions 30. As shown in FIG. 3, the display portions 30 include: a plurality of display pixel electrodes 31 corresponding to the pixels 50a; a display common electrode 32 that is arranged opposite the display pixel electrodes 31 and that is a single electrode common to all the pixels; and display layers 33 arranged between the display pixel electrodes 31 and the display common electrode 32.

In the first embodiment, the display layer 33 of the display portion 30 is formed of a liquid crystal composition. Hence, the display layer 33 functions as a dielectric substance, and thus the display portion 30 is represented as a capacitor C_{LC} in FIGS. 1 to 3. The thin film transistor element (TFT) 10 is an example of a “switching element” of the present invention. Moreover, the display pixel electrode 31 and the display common electrode 32 are one example of a “first pixel electrode” and a “first common electrode”, respectively of the present invention.

Each of the pixels 50a of the pixel array portion 50 has one of the TFTs 10 and one of the photoelectric conversion portions (photodiodes) 20.

In the first embodiment, as shown in FIGS. 1 to 3, in each of the pixels 50a of the pixel array portion 50, the display pixel electrode 31 and the cathode electrode (photoelectric conversion pixel electrode) of the photoelectric conversion portion 20 are electrically connected to each other. The display pixel electrode 31 and the cathode electrode (photoelectric conversion pixel electrode) of the photoelectric conversion portion 20 electrically connected to each other are connected to a drain electrode that is one of the input/output terminals of the TFT 10. On the other hand, a source electrode that is the other input/output terminal of the TFT 10 is connected to a signal line 51, and the signal line 51 is connected to a charge sensing amplifier 71, which will be described later. The charge sensing amplifier 71 is an example of an “amplifier portion” of the present invention.

The gate electrode of the TFT 10 is connected to a scanning line 11, and the scanning line 11 is connected to an output terminal of the scanning drive circuit 60. The scanning drive circuit 60 sequentially outputs positive voltages to scan the scanning line 11. Thus, the turning on and off of the TFT 10 is controlled by scanning the scanning line 11. Hence, by controlling the turning on and off of the TFT 10, it is possible to switch between an “on” state and an “off” state a connection between the display pixel electrode 31 and the cathode electrode (photoelectric conversion pixel electrode) of the photoelectric conversion portion 20 electrically connected to each other and the charge sensing amplifier 71.

In the first embodiment, a direct-current voltage source 40 that applies a direct-current voltage (potential) to the display common electrode 32 and a switch 41 are provided. This direct-current voltage source 40 is connected to the display common electrode 32 through the switch 41. Hence, when the switch 41 is turned on, a predetermined potential (constant potential) is applied to the display common electrode 32. The anode electrode (photoelectric conversion common electrode) of the photoelectric conversion portion (photodiode) 20 is connected to a bias line 52, and the bias line 52 is grounded. Hence, when the switch 41 is turned on, the direct-current voltage source 40 applies a constant voltage V_{E} between the display common electrode 32 of the display portion 30 and the anode electrode (photoelectric conversion common electrode). On the other hand, when the switch 41 is turned off, the display common electrode 32 is floated. In other words, in the image input/output device of the first embodiment, the turning on and off of the switch 41 allows the display common electrode 32 to switch between a constant potential state and a floated state.

As shown in FIG. 2, the column output circuit 70 includes the charge sensing amplifier 71, switches 72 and 73 and sample and hold circuits 74 and 75.

As shown in FIG. 3, the charge sensing amplifier 71 is composed of an operational amplifier 71a, a capacitor 71b and a switch 71c. The signal line 51 is connected to the inverting input terminal of the operational amplifier 71a of the charge sensing amplifier 71; a reference voltage V_{REF} is applied from a reference power supply 120 to the non-inverting input terminal of the operational amplifier 71a. The capacitor 71b and the switch 71c are connected in parallel between the inverting input terminal of the operational amplifier 71a and the output terminal. The turning on and off of the switch 71c is controlled by a signal ØRST that is fed from the timing generator 100 (see FIG. 2) through a reset line 53. The charge sensing amplifier 71 configured as described above is a read circuit that has an integration function by holding electrical signals in the capacitor 71b, and has the characteristic of holding electrical signals even when an attempt to read the electrical signals is made unless the capacitor 71b is reset.

As shown in FIG. 2, the output terminal of the operational amplifier 71a is connected through the switch 72 to the input terminal of the sample and hold circuit 74, and is also connected through the switch 73 to the input terminal of the sample and hold circuit 75. The output terminals of the sample and hold circuits 74 and 75 are connected to the input side of the multiplexer 80. An output signal MX output from the multiplexer 80 is converted from analog to digital by the A-D converter 90.

The timing generator 100 controls the timing of operation of the scanning drive circuit 60, the column output circuits 70, the multiplexer 80 and the A-D converter 90, feeds the signal ØRST to the switch 71c (see FIG. 3), feeds a signal ØSHR to the switch 72 and feeds the signal ØSHS to the switch 73.

The memory 110 is formed with, for example, a rewritable flash memory, and records digital data (image data) output from the A-D converter 90.

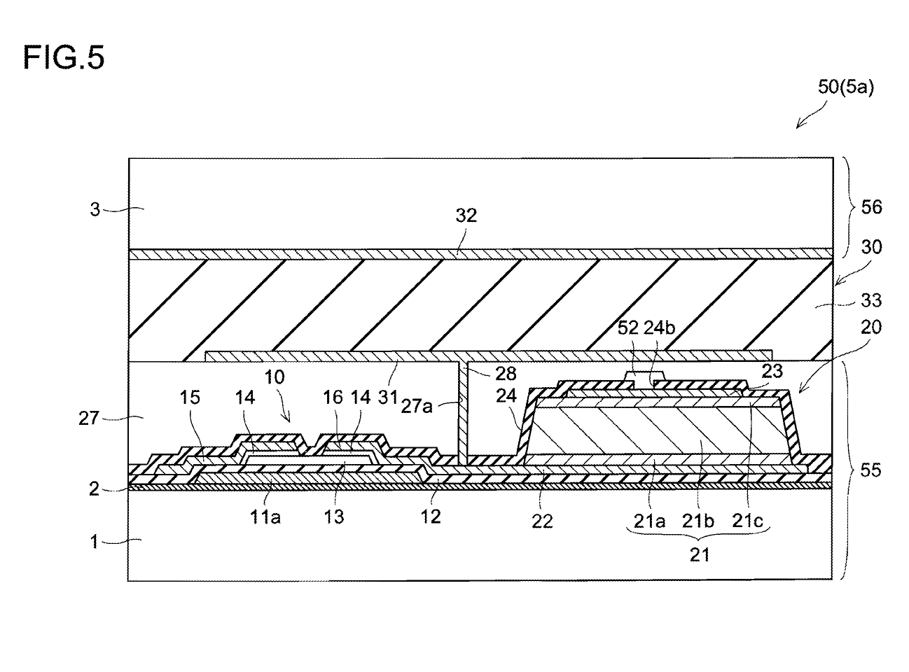

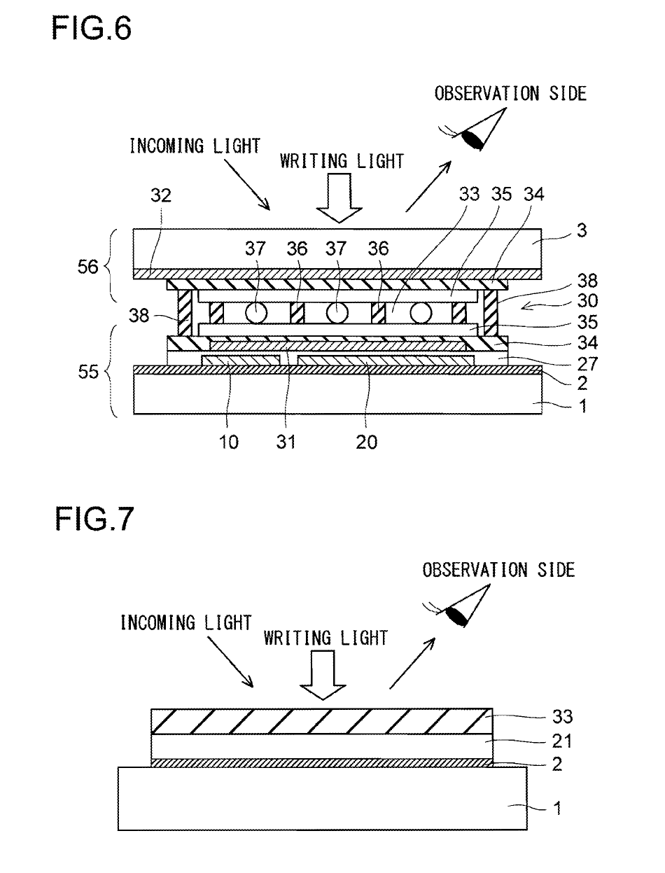

FIG. 4 is a plan view showing part of the pixel array portion of the image input/output device according to the first embodiment of the present invention; FIG. 5 is a cross-sectional view taken along line A-A of FIG. 4. FIGS. 6 to 11 are diagrams illustrating the configuration of the image input/output device according to the first embodiment of the present invention. While the display portion and the like are omitted in FIG. 4, the omitted portions are shown in FIG. 5. FIGS. 4 and 5 show the structure of one pixel in the pixel array portion 50. The structure of the pixel array portion 50 of the image input/output device according to the first embodiment of the present invention will now be described with reference to FIGS. 3 to 11.

As shown in FIGS. 5 and 6, the pixel array portion 50 of the image input/output device according to the first embodiment includes an array substrate 55 and an opposite substrate 56 opposite the array substrate 55; the display layer 33 is sandwiched between the array substrate 55 and the opposite substrate 56.

The array substrate 55 includes a first substrate 1 having a thickness of about 0.7 mm and formed of alkali-free glass. This first substrate 1 has optical transparency; a light absorbent layer 2 that absorbs visible light is so formed on the first substrate 1 as to have a predetermined thickness. On the light absorbent layer 2, a plurality of pixels 50a are arranged in a two-dimensional matrix, and thus the pixel array is formed. Each of the pixels 50a of the pixel array includes: the photoelectric conversion portion 20 that converts light into electric charge (electrical energy); and the TFT 10 for reading the electrical signals of the electric charge. The first substrate 1 is an example of a “substrate” of the present invention. The size of the pixel 50a is 50 μm; the pixel pitch is 800 μm.

The TFT 10 is configured in a bottom-gate/top-contact structure. Specifically, the gate electrode 11a formed with a Cr (chromium) layer about 140 nm thick is formed in a predetermined region on the light absorbent layer 2. This gate electrode 11a is formed integrally with a gate wiring layer 11 functioning as the scanning line. The gate wiring layer 11 is formed with a Cr layer about 140 nm thick so as to extend in a row direction. On the upper surface of the first substrate 1, as shown in FIG. 5, an insulation layer 12 having a thickness of about 400 nm and made of SiNx is formed over the entire surface of the gate electrode 11a and the gate wiring layer 11. In a predetermined region on the insulation layer 12 positioned above the gate electrode 11a, a semiconductor layer 13 made of a-Si (amorphous silicon) is formed. Furthermore, on the semiconductor layer 13, an ohmic contact layer 14 made of n⁺a-Si is formed. A source electrode 15 and a drain electrode 16 are formed in contact with the ohmic contact layer 14.

As shown in FIG. 4, in a predetermined region on the insulation layer 12, a wiring layer 51 functioning as the signal line is formed to extend in a column direction. This wiring layer 51 is formed with a Cr layer about 140 nm thick. The source electrode 15 of the TFT 10 is electrically connected to the wiring layer 51.

As shown in FIGS. 4 and 5, the photoelectric conversion portion 20 includes: a photoelectric conversion layer 21 made of semiconductor material capable of photoelectric conversion; and two electrodes (photoelectric conversion pixel electrode 22 and photoelectric conversion common electrode 23) that vertically sandwich the photoelectric conversion layer 21. This photoelectric conversion pixel electrode 22 is arranged on the side of the first substrate 1 with respect to the photoelectric conversion layer 21; the photoelectric conversion common electrode 23 is arranged on the opposite side of the first substrate 1 with respect to the photoelectric conversion layer 21. The photoelectric conversion portions 20 are formed in regions other than the regions where the TFTs 10 are formed such that they are separated pixel by pixel.

Specifically, in predetermined regions on the light absorbent layer 2, the photoelectric conversion pixel electrodes 22 separated pixel by pixel are formed to have a predetermined plane area (pattern). The photoelectric conversion pixel electrode 22 has a thickness of about 40 nm, and is formed of an electrically conductive material having optical transparency, namely, ITO (indium tin oxide). In each of the pixels 50a, the photoelectric conversion pixel electrode 22 is electrically connected to the drain electrode 16 of the TFT 10. The photoelectric conversion layer 21 is formed on the photoelectric conversion pixel electrode 22. This photoelectric conversion layer 21 is formed with a PIN photoelectric conversion film obtained by sequentially depositing, from the side of the photoelectric conversion pixel electrode 22, an N-type amorphous silicon layer 21a having a thickness of about 50 nm, an I-type amorphous silicon layer 21b having a thickness of about 500 nm and a P-type amorphous silicon layer 21c having a thickness of about 15 nm. The photoelectric conversion common electrode 23 is formed on the P-type amorphous silicon layer 21c of the photoelectric conversion layer 21. This photoelectric conversion common electrode 23 is formed with an ITO film having a thickness of about 70 nm. Thus, as described above, in the photoelectric conversion portion 20, the photoelectric conversion pixel electrode 22 serves as the cathode electrode, and the photoelectric conversion common electrode 23 serves as the anode electrode. The photoelectric conversion pixel electrode 22 and the photoelectric conversion common electrode 23 are one example of a “second pixel electrode” and a “second common electrode”, respectively of the present invention.

On the first substrate 1, a passivation film 24 made of SiNx is formed to cover the TFT 10 and the photoelectric conversion portion 20. On the passivation film 24, the bias wiring layer 52 serving as the bias line is formed to extend in a column direction; the bias wiring layer 52 and the photoelectric conversion common electrode 23 are electrically connected to each other through a contact hole 24b formed in a predetermined part of the passivation film 24. In this way, the TFT 10 and the photoelectric conversion portion 20 are configured in a bias top structure. A planarization film 27 made of photosensitive acrylate resin and the like is formed on the upper surface of the first substrate 1 to cover the TFT 10 and the photoelectric conversion portion 20.

In predetermined regions on the planarization films 27, the display pixel electrodes 31 are formed such that they are separated pixel by pixel. The display pixel electrode 31 is formed with an ITO film to have a predetermined plane area (pattern). The resistance of the ITO sheet of the display pixel electrode 31 is 10 Ω/square.

In the first embodiment, in predetermined parts of the planarization film 27 and the passivation film 24, a contact hole 27a reaching the photoelectric conversion pixel electrode 22 is formed. A connection wiring 28 is formed within the contact hole 27a; the display pixel electrode 31 and the photoelectric conversion pixel electrode 22 are electrically connected to each other through the display portion 28.

As shown in FIG. 6, on the planarization film 27, an insulation thin film 34 is formed to cover the display pixel electrode 31; on the insulation thin film 34, an alignment film 35 about 60 mm thick is formed.

The opposite substrate 56 includes a second substrate 3 having optical transparency; the display common electrode 32 is formed over the entire surface of the second substrate 3 opposite the first substrate 1. This display common electrode 32 is formed with an ITO film having a predetermined thickness. On the display common electrode 32, the insulation thin film 34 is formed; on the insulation thin film 34, the alignment film 35 having a thickness of about 60 nm is formed. As the second substrate 3 having optical transparency, a flexible substrate can be used that is formed with a glass substrate and resin such as polycarbonate, polyether sulfone, polyarylate or polyethylene terephthalate.

The array substrate 55 and the opposite substrate 56 are arranged opposite each other such that the alignment films face each other; the array substrate 55 and the opposite substrate 56 sandwich the display layer 33. Polymer structures 36 and spacers 37 are provided between the array substrate 55 and the opposite substrate 56. The polymer structure 36 functions both as a space holding member and as an adhesive member that bonds both the substrates. The spacer 37 functions as a space holding member; the spacer 37 is provided in order to hold a constant space (cell gap) between both the substrates. As the spacer 37, for example, Micropearl (5.0 μm) produced by Sekisui Fine Chemical Co. Ltd. can be used. Thus, the space (cell gap) between both the substrates is set at about 5 μm. Then, the display layer 33 between the array substrate 55 and the opposite substrate 56 is sealed by seal members 38. As the seal member 38, for example, Sumilite ERS-2400 (base compound)+ERS-2840 (hardener) produced by Sumitomo Bakelite Co., Ltd. can be used.

For example, the insulation thin film 34 is formed with: an inorganic film made of oxide silicon, titanium oxide, zirconium oxide or their alkoxide; and an organic film made of polyimid resin, epoxy resin, acrylic resin or urethane resin. The insulation thin film 34 can be formed with these materials by a method such as an evaporation method, a spin coat method or a roll coating method. The insulation thin film 34 can also be formed of the same material as a high polymer resin used in the polymer structure 36. The alignment film 35 is made of soluble polyimide (for example, a vertical alignment film AI-2022 produced by JSR Corporation), and can be formed by a printing method or the like.

As described above, the pixel array portion 50 of the image input/output device according to the first embodiment has the display portions 30 composed of display elements including at least the display layers 33, the display pixel electrodes 31 and the display common electrode 32. As shown in FIGS. 5 and 6, the display portion (display element 30) is arranged above the TFT 10 and the photoelectric conversion portion 20 (on the opposite side of the first substrate 1). In other words, as shown in FIG. 7, the photoelectric conversion layer 21 and the display layer 33 are sequentially formed on the first substrate 1 from the first substrate 1. The direct-current voltage source 40 (see FIG. 3) is connected through the switch 41 (see FIG. 3) between the display common electrode 32 and the photoelectric conversion common electrode 23. As described above, the photoelectric conversion common electrode 23 of the photoelectric conversion portion 20 is connected to the bias wiring layer (bias line) 52 (see FIG. 3), and the bias wiring layer (bias line) 52 is grounded.

As shown in FIGS. 6 and 7, in the image input/output device of the first embodiment, the upper surface side (front surface side) of the first substrate 1 is the observation side. Writing light that is pattern light representing an image is applied from the upper surface side (front surface side) of the first substrate 1. In other words, exposure is performed from the same side as the observation side. Furthermore, when the image input/output device (pixel array portion 50) of the first embodiment is seen from the observation side, the light absorbent layer 2 is arranged (formed) on the back surface side of the display layer 33.

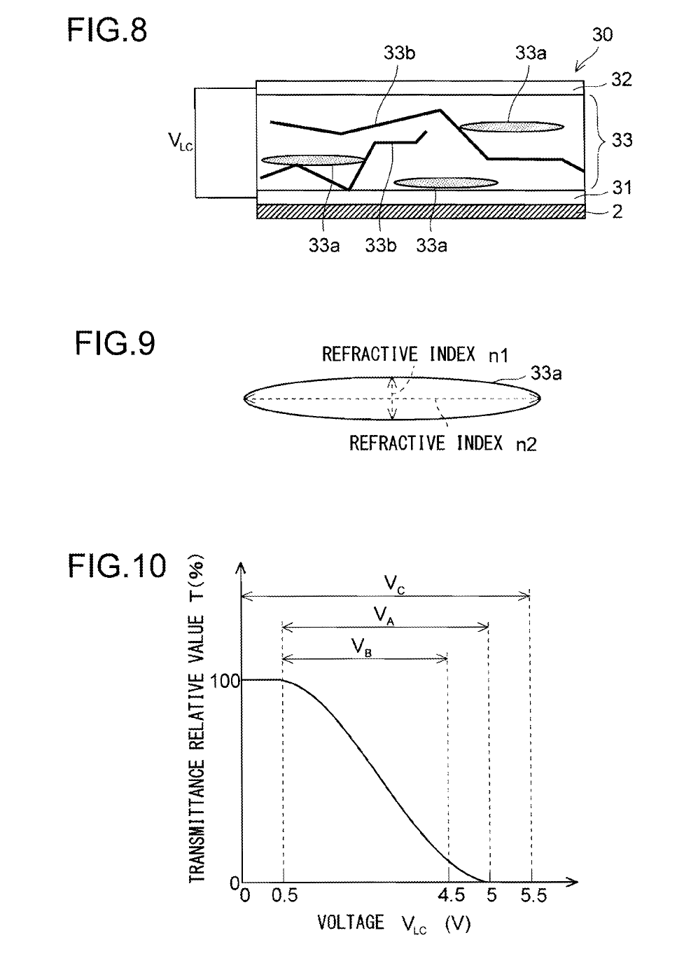

In the first embodiment, as shown in FIG. 8, the display layer 33 of the display portion 30 is formed with a transmission scattering liquid crystal layer containing a nematic liquid crystal 33a and a polymer 33b. Specifically, the display layer 33 is formed of a uniformly mixed solution between the nematic liquid crystal and a photopolymerization monomer; a fine three-dimensional polymer network structure is formed in the liquid crystal by ultraviolet photopolymerization. This induces light scattering.

In the nematic liquid crystal (liquid crystal molecule) 33a, as shown in FIG. 9, a refractive index (n1) along its short axis agrees with the refractive index (n1) of the polymer 33b (see FIG. 8), and a refractive index (n2) along its long axis differs from the refractive index (n1) of the polymer 33b.

When a voltage V_{LC} is applied to the display layer 33 configured as described above, the liquid crystal molecules 33a of the nematic liquid crystal are aligned according to the applied voltage V_{LC}. Specifically, as shown in FIG. 11, when no voltage or a low voltage is applied as the voltage V_{LC} to the display layer 33, the long axes of the liquid crystal molecules 33a are aligned parallel to the plane of the substrate, and the liquid crystal molecules 33a lie. Thus, the liquid crystal molecules 33a are aligned along the polymer 33b, and this reduces the difference in refractive index between the liquid crystal molecules and the polymer 33b. (The refractive index of the liquid crystal molecules 33a agrees with that of the polymer 33b.) Hence, no reflection occurs on the boundary between the liquid crystal molecules 33a and the polymer 33b, and the display layer 33 is brought into a state in which light is transmitted. Consequently, light that has entered the display layer 33 is transmitted through the display layer 33 and is absorbed by the light absorbent layer 2 (see FIGS. 7 and 8), and appears black.

On the other hand, when a high voltage is applied as the voltage V_{LC} to the display layer 33, the long axes of the liquid crystal molecules 33a are aligned perpendicular to the plane of the substrate (aligned in the direction of the electric field), and the liquid crystal molecules 33a stand up. This increases the difference in refractive index between the liquid crystal molecules and the polymer 33b. (The refractive index of the liquid crystal molecules 33a differs from that of the polymer 33b.) Hence, when light enters the display layer 33, reflection occurs on the boundary between the liquid crystal molecules 33a and the polymer 33b, and the light that has entered the display layer 33 is backscattered. Consequently, the display appears white.

As described above, as the voltage V_{LC} applied to the display layer 33 is varied, the alignment of the liquid crystal molecules 33a is varied, and thus the display state of the display portion 30 is varied.

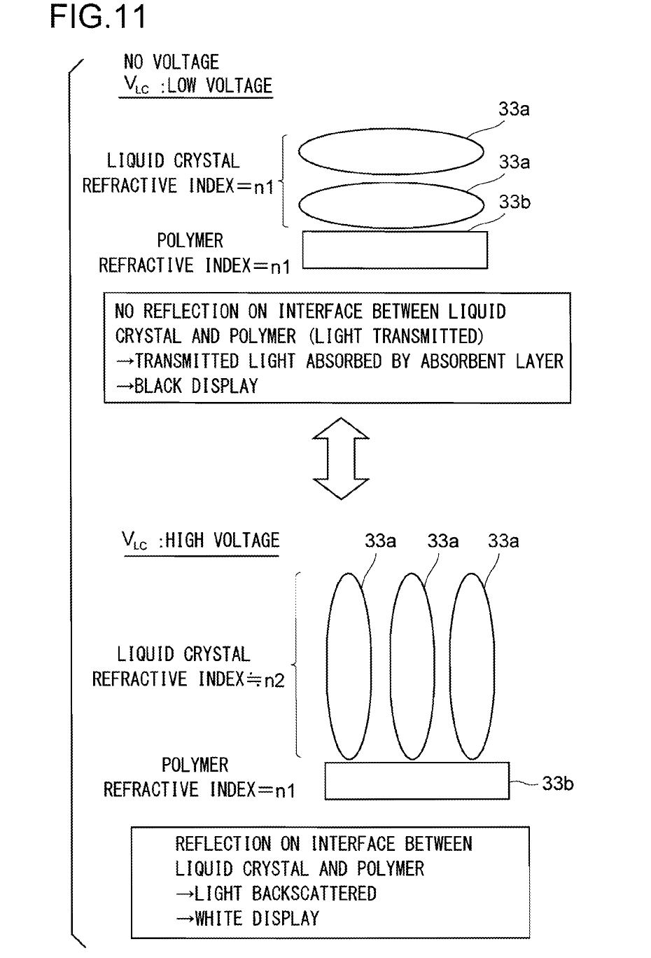

In the image input/output device of the first embodiment, the display element 30 is adjusted to have a characteristic as shown in FIG. 10. Specifically, a nematic liquid crystal composition is obtained by mixing a nematic liquid crystal (BL006; produced by Merck & Co., Inc., refractive index anisotropy: 0.286, permittivity anisotropy: 17.3, viscosity: 71 mP·s, NI point: 113° C.) with a monomer (KAYARAD R-684; produced by Nippon Kayaku Co., Ltd.) and a polymerization initiator (Darocure 1173; produced by Nagase Co., Ltd.). These mixing ratios are as follows.
monomer:polymerization initiator=97:3 (weight ratio)
monomer+polymerization initiator:nematic liquid crystal=5:95 (weight ratio)

UV rays with an illuminance of 5 mW/cm² are applied for five minutes to the obtained display element, and thus the display element 30 having the characteristic shown in FIG. 10 is obtained. The obtained display element 30 is adjusted such that, when a voltage of 0.5 volts is applied as the voltage V_{LC}, the transmittance is 100%, and that, when a voltage of 5 volts is applied as the voltage V_{LC}, the transmittance is 0%. In this case, when the voltage V_{LC} is 0.5 volts, the display is black whereas, when the voltage V_{LC} is 5 volts, the display is white. The voltage V_{LC} applied to the display layer 33 (display portion 30) is set to range from 0.5 to 5 volts. The potential difference between these voltages can be used as a potential difference V_{A} necessary to change the display state from the “on” state to the “off” state.

In the above configuration, an auxiliary capacity is provided for the photoelectric conversion portion 20.

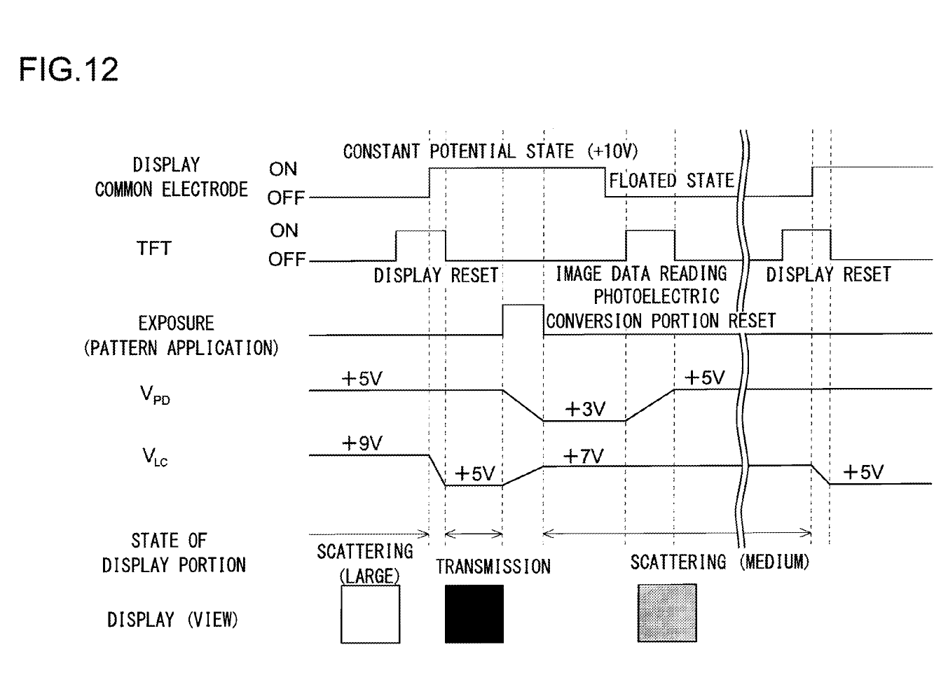

FIG. 12 is a timing chart illustrating the operation of the image input/output device according to the first embodiment of the present invention. The operation of the image input/output device according to the first embodiment of the present invention will be described with reference to FIGS. 1 to 3, 6, 7 and 10 to 12. In the following description of the operation, when a voltage of +5 volts is applied as the voltage V_{LC} to the display portion (display element) 30, the transmittance T of the display layer 33 (display element 30) is assumed to be set at 100% (corresponding to when V_{LC}=0.5 volts in FIG. 10).

High-level signals ØRST are fed from the timing generator 100 (see FIG. 2), and thus the switches 71c (see FIG. 3) of the charge sensing amplifiers 71 are turned on. With the switches 71c on, the scanning drive circuit 60 (see FIGS. 1 and 2) outputs a positive voltage to the scanning lines 11 (see FIGS. 1 to 3). Thus, all the TFTs 10 connected to the scanning lines 11 are turned on. Since the switch 71c is on, the output terminal and the inverting input terminal of the operational amplifier 71a are connected, and the charge sensing amplifier 71 is reset. As shown in FIGS. 1 to 3, when the TFT 10 is turned on, the cathode electrode (photoelectric conversion pixel electrode 22) of the photoelectric conversion portion (photodiode) 20 is electrically connected to the output terminal of the operational amplifier 71a through the TFT 10 and the switch 71c. In this way, the photoelectric conversion portion (photodiode) 20 is set to the initial state.

When the charge sensing amplifier 71 is reset, the signal ØSHR is fed from the timing generator 100, and the switch 72 of the column output circuit 70 is turned on. The output of the charge sensing amplifier 71 at the time of reset is sampled and held by the sample and hold circuit 74.

As shown in FIGS. 3 and 12, when the TFT 10 is turned on, the reference voltage V_{REF} (for example, +5 volts) is applied to the photoelectric conversion pixel electrode 22 (cathode electrode) of the photoelectric conversion portion 20. Since the photoelectric conversion common electrode (anode electrode) 23 of the photoelectric conversion portion (photodiode) 20 is grounded, the voltage V_{PD} (voltage applied across the photoelectric conversion portion 20) of the photoelectric conversion portion (photodiode) 20 becomes equal to the reference voltage V_{REF} which is 5 volts. Here, a reverse bias voltage is applied to the photoelectric conversion portion (photodiode) 20.

Then, when the switch 41 is turned on and a constant potential (for example, +10 volts) is applied to the display common electrode 32, since the voltage V_{PD} (the potential of the photoelectric conversion pixel electrode 22 of the photoelectric conversion portion 20) of the photoelectric conversion portion (photodiode) 20 is +5 volts, the voltage V_{LC} (voltage applied across the display portion 30) applied to the display portion 30 becomes +5 volts (=(+10 volts)−(+5 volts)). When the voltage V_{LC} is +5 volts, the display portion 30 is set to transmit light (its transmittance T is 100%), and hence the display (view) turns black. Thus, the display of the display portion 30 is reset to the initial state. Then, the scanning drive circuit 60 turns off all the TFTs 10.

Then, as shown in FIGS. 6, 7 and 12, the writing light, which is pattern light representing an image, is applied (exposure (pattern application)) from the upper surface side (front surface side) of the first substrate 1, and thus the image is written. Specifically, since, in the above state, the display portion 30 (display layer 33) transmits light, when the writing light is applied from the upper surface side (front surface side) of the first substrate 1, the applied writing light is transmitted through the display portion 30 and is received by the photoelectric conversion portion (photodiode) 20. Inside the photoelectric conversion portion (photodiode) 20 that has received the writing light, electron-hole pairs are generated. Hence, charge stored in the photoelectric conversion portion (photodiode) 20 is reduced by the amount of charge corresponding to the generated electron-hole pairs. Thus, as shown in FIG. 12, in a pixel, the voltage V_{PD} of the photoelectric conversion portion (photodiode) 20 is varied, for example, from +5 volts to +3 volts. Since a constant voltage (+10 volts) is maintained at the display common electrode 32, the voltage V_{LC} of the display portion 30 (the corresponding display pixel) is varied from +5 volts to +7 volts as the voltage V_{PD} of the photoelectric conversion portion (photodiode) 20 is varied. In other words, the photoelectric conversion portion (photodiode) 20 receives the pattern light, and thus the division of the voltage of the display portion 30 is changed. This causes the alignment of the liquid crystal molecules 33a (see FIG. 1) to be changed, and the display state of the display portion 30 is changed accordingly. For example, a moderate amount of scattering is produced, and thus the display turns gray.

Since the writing light is applied to vary the display state of the display portion 30 of each pixel in this way, the image is written instantaneously. In other words, the application of the pattern light (exposure) representing an image allows the image corresponding to the pattern light (exposure pattern) to be instantaneously displayed on the display portion 30.

Then, with the image displayed, the switch 41 (see FIG. 3) is turned off, and, as shown in FIG. 12, the display common electrode 32 (see FIG. 3) is switched to the floated state. Thus, the image is continuously displayed.

After the application of the pattern light, scanning is performed to read image data on the written image. In the reading scanning, the switch 71c (see FIG. 3) of the charge sensing amplifier 71 is first turned off. Then, the scanning drive circuit 60 outputs a positive voltage to the scanning line 11, and thus the TFTs 10 are turned on row by row. By doing so, a current flows through the signal line 51, and a voltage resulting from the charge-to-voltage conversion is output from the operational amplifier 71a. The voltage resulting from the charge-to-voltage conversion corresponds to the charge removed from the photoelectric conversion portion (photodiode) 20 at the time of the application of the pattern light. In this way, pixel output signals (voltages) are read by the charge sensing amplifiers 71 in the column output circuits 70 (see FIG. 2). At the same time that the scanning is performed to read the image data, the photoelectric conversion portion (photodiode) 20 is reset to the initial state. Even when the scanning is performed to read the image data or the photoelectric conversion portion (photodiode) 20 is reset, unless the display portion 30 is reset, the display of the written image is maintained for a while.

Then, the signal ØSHS is fed from the timing generator 100 (see FIG. 2), and the switch 73 of the column output circuit 70 is turned on, with the result that output of the charge sensing amplifier 71 at the time of reading of the pixel output signal (voltage) is sampled and held by the sample and hold circuit 75.

Thereafter, the output signals sampled and held are sequentially selected by the multiplexer 80, are converted into electrical signals and are transmitted to the A-D converter 90. By obtaining the difference between the output of the charge sensing amplifier 71 at the time of reset and the output of the charge sensing amplifier 71 at the time of reading of the pixel output signal, correlated double sampling processing is performed.

Thereafter, the electrical signals transmitted from the multiplexer 80 are converted into digital data by the A-D converter 90.

This type of operation is performed on all the pixels, and thus image information on the written image is acquired as image data. Then, the acquired image data is recorded in the memory 110.

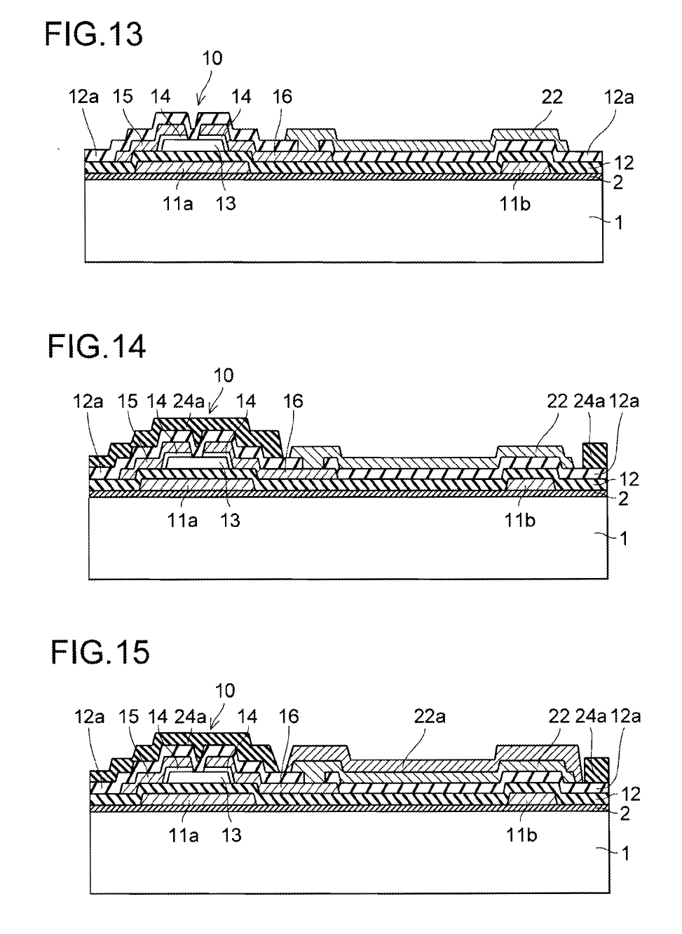

FIGS. 13 to 20 are cross-sectional views illustrating a method of manufacturing the array substrate of the image input/output device according to the first embodiment of the present invention. The method of manufacturing the array substrate 55 of the image input/output device according to the first embodiment of the present invention will now be described with reference to FIGS. 5 and 13 to 20. A case where an auxiliary capacity is provided in the photoelectric conversion portion 20 will be described below.

As shown in FIG. 13, the light absorbent layer 2 is first formed by the printing method or the like on the first substrate 1 having a thickness of about 0.7 mm and formed of alkali-free glass. Then, the TFT 10 is formed on the light absorbent layer 2. In the formation of the TFT 10, the Cr layer about 140 nm thick is first formed on the light absorbent layer 2 by sputtering or the like, and photolithography technology and etching technology are used to form the gate electrode 11a and an auxiliary capacity electrode 11b. Then, the insulation layer 12 having a thickness of about 400 nm and made of SiNx is formed, by plasma CVD or the like, over the entire surface of the gate electrode 11a and the auxiliary capacity electrode 11b.

Then, in the predetermined region on the insulation layer 12, the semiconductor layer 13 made of a-Si and the ohmic contact layer 14 made of n⁺a-Si are formed by plasma CVD or the like. Then, after the Cr layer about 140 nm thick is formed by sputtering or the like, the source electrode 15 and the drain electrode 16 are formed by patterning. Thereafter, an insulation layer 12a having a thickness of about 130 nm and made of SiNx is formed. In this way, the TFT 10 is formed on the first substrate 1.

Then, the photoelectric conversion pixel electrode 22 formed with an ITO film having a thickness of about 40 nm is formed. Here, the photoelectric conversion pixel electrode 22 is so formed as to be electrically connected to the drain electrode 16 of the TFT 10.

Then, as shown in FIG. 14, a passivation film 24a is formed on the TFT 10. Specifically, the passivation film 24a having a thickness of about 300 μm is formed by plasma CVD using 20% SiH₄ (diluted with N₂) as a raw gas. Here, the temperature for the film formation is about 200° C. The passivation film 24a is patterned such that the photoelectric conversion pixel electrode 22 is exposed. The passivation film 24a can be patterned with a RIE dry etching device 10NR under the following conditions.
Gases used: CF₄ (flow rate: 11 sccm), CHF₃ (flow rate: 14 sccm)
RF output: 244 W
Set pressure: 6.7 Pa
Etching rate: 121.4 nm/min.
Etching time: 5 min.

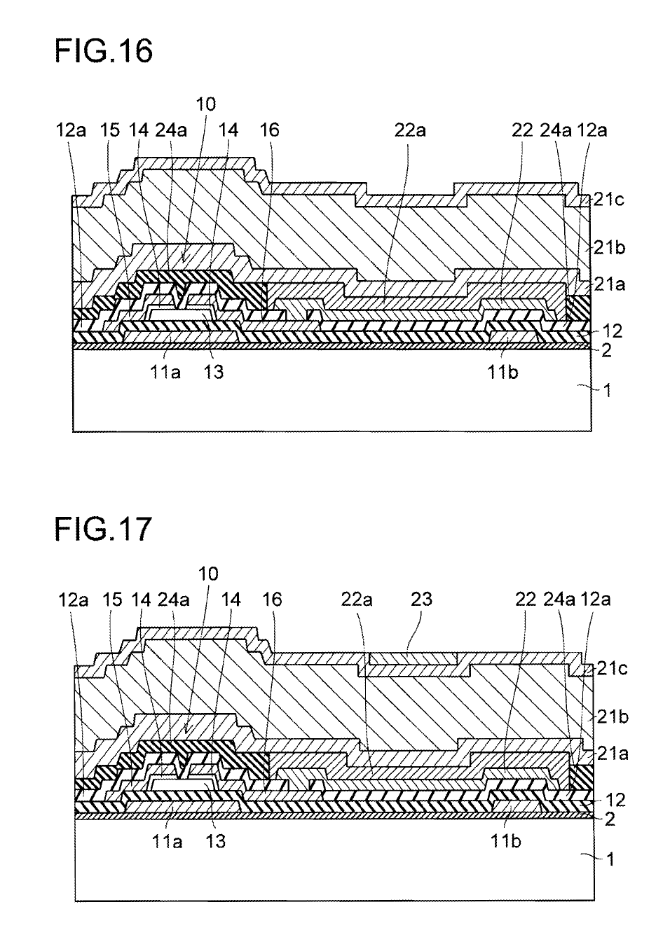

Then, as shown in FIG. 15, a Cr layer 22a about 50 nm thick is formed on the photoelectric conversion pixel electrode 22, and the photoelectric conversion layer is formed on the first substrate 1. Specifically, as shown in FIG. 16, the N-type amorphous silicon layer 21a having a thickness of about 50 nm, the I-type amorphous silicon layer 21b having a thickness of about 500 nm and the P-type amorphous silicon layer 21c having a thickness of about 15 nm are sequentially formed from the side of the first substrate 1 by plasma CVD or the like. Then, as shown in FIG. 17, the photoelectric conversion common electrode 23 formed with an ITO film having a thickness of about 70 nm is formed on the P-type amorphous silicon layer 21c by sputtering. The photoelectric conversion common electrode 23 can be formed with a magnetron sputtering device under the following conditions.
Possible degree of vacuum: 5×10⁻⁴ Pa
Distance between electrodes: 65 mm
Temperature for film formation on substrate: room temperature
Pressure: 1 Pa
RF Power: 100 W
Time for film formation: 13 min.

The ITO film is patterned under the following conditions.
Etchant: ITO etchant
Etching time: 20 min.

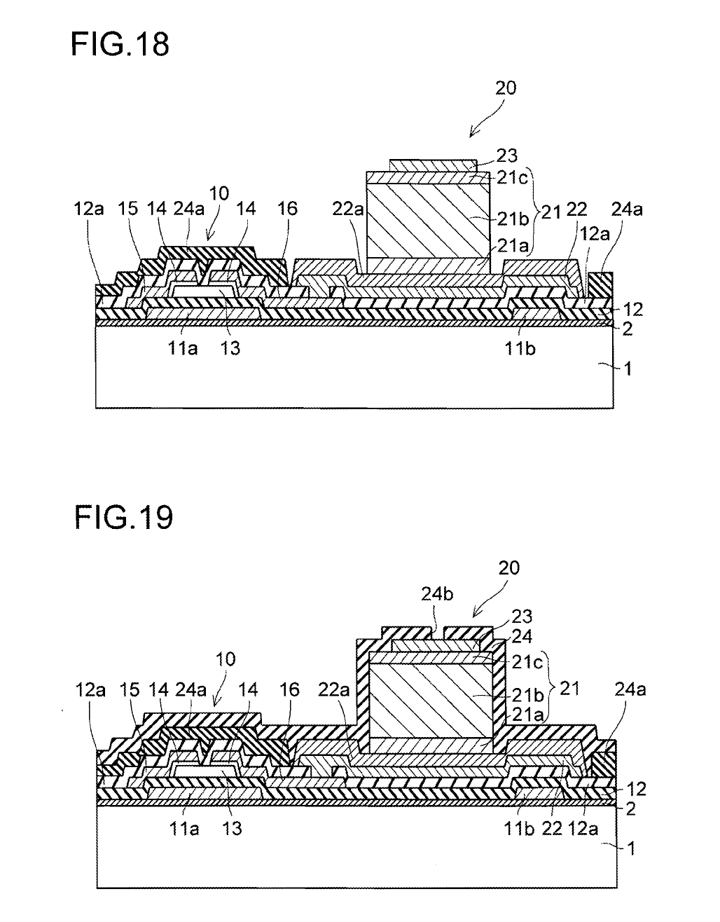

Thereafter, as shown in FIG. 18, the N-type amorphous silicon layer 21a, the I-type amorphous silicon layer 21b and the P-type amorphous silicon layer 21c are patterned, with the result that the PIN photoelectric conversion layers 21 separated pixel by pixel are formed. In this way, the photoelectric conversion portion 20 is formed, which includes: the photoelectric conversion layer 21; and the photoelectric conversion pixel electrode 22 and the photoelectric conversion common electrode 23 sandwiching the photoelectric conversion layer 21. The patterning for obtaining the photoelectric conversion layer 21 can be performed with the RIE dry etching device 10NR under the following conditions.
Gases used: SF₆ (flow rate: 21 sccm), O₂ (flow rate: 9 sccm)
RF output: 30 W
Set pressure: 6.7 Pa
Etching rate: 117 nm/min.
Etching time: 5 min.

Then, as shown in FIG. 19, the passivation film 24 is formed to cover the TFT 10 and the photoelectric conversion portion 20. This passivation film 24 can be formed under the same conditions as the passivation film 24a. Then, the contact hole 24b is formed in the predetermined part of the passivation film 24. The formation of the contact hole 24b can be performed under the same conditions as those for patterning the passivation film 24a.

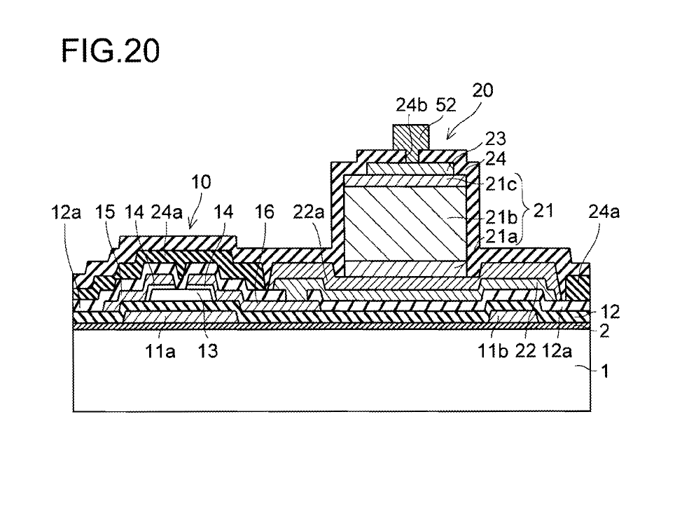

Then, as shown in FIG. 20, the bias wiring layer 52 electrically connected to the photoelectric conversion common electrode 23 through the contact hole 24b is formed. Thereafter, as shown in FIG. 5, the planarization film 27 is formed on the first substrate 1, and the display pixel electrode 31 electrically connected to the photoelectric conversion pixel electrode 22 is formed on the planarization film 27.

In this way, the array substrate 55 of the image input/output device according to the first embodiment is manufactured.

In the image input/output device of the first embodiment, as described above, the display pixel electrode 31 of the display portion 30 and the photoelectric conversion pixel electrode 22 of the photoelectric conversion portion 20 are electrically connected to each other and the display common electrode 32 is switched to the constant potential state, and thus it is possible to apply a predetermined potential (voltage) to the display layer 33 (display portion 30) and the photoelectric conversion layer 21 (photoelectric conversion portion 20). When, in this state, the pattern light is applied to the photoelectric conversion layer 21 (photoelectric conversion portion 20), in each pixel 50a, the potential (voltage) applied to the photoelectric conversion layer 21 is varied according to the amount of light applied. Then, as the potential (voltage) applied to the photoelectric conversion layer 21 is varied, the potential (voltage, divided voltage) applied to the display layer 33 is varied. Thus, it is possible to vary the display state of the display portion 30 according to the amount of light applied. In this way, it is possible to display an image on the display portion 30. Consequently, with the configuration described above, it is possible to instantaneously write an image by applying an optical pattern. For example, it is possible to instantaneously copy an optical image or the like on a light-emitting display screen.

Since the display common electrode 32 has a constant potential applied thereto, and thus the display layer 33 of the display portion 30 is kept in a substantially transmissive state, it is possible to display on the display portion 30 an image corresponding to an exposure pattern by performing exposure with the display layer 33 in the substantially transmissive state.

In the first embodiment, since the above configuration is employed, and thus charge is stored in the photoelectric conversion layer 21 according to the display image, it is possible to acquire image information on the written image as image data by reading the charge stored in the photoelectric conversion layer 21.

With the configuration and the operation of the first embodiment described above, it is possible to satisfactorily display an image and acquire image data.

### Second Embodiment

The configuration of the second embodiment differs from that of the first embodiment in that the image input/output device of the second embodiment is set such that the potential difference between a potential applied to the display common electrode 32 and a potential applied to reset the photoelectric conversion portion 20 is less than the potential difference V_{A} (see FIG. 10) necessary to change the display state from the “on” state to the “off” state. In other words, in the image input/output device of the second embodiment, the reference voltage V_{REF} and the voltage V_{E} of the direct-current voltage source 40 are set such that the range of change of the voltage V_{LC} applied to the display layer 33 (display portion 30) is equal to V_{B} that is less than V_{A} shown in FIG. 10. Specifically, the reference voltage V_{REF} and the voltage V_{E} of the direct-current voltage source 40 are set such that the range of change of the voltage V_{LC} applied to the display layer 33 (display portion 30) corresponds to 0.5 to 4.5 volts.

Thus, in the image input/output device of the second embodiment, since variations in image density can be displayed between a minute exposure amount and the vicinity of a saturated exposure amount, it is possible to display an image on the display portion 30 with satisfactory contrast.

The other parts of the configuration of the image input/output device of the second embodiment are the same as in the first embodiment. The other effects of the second embodiment are also the same as those of the first embodiment.

### Third Embodiment

The configuration of the third embodiment differs from that of the first embodiment in that the image input/output device of the third embodiment is set such that the potential difference between the potential applied to the display common electrode 32 and the potential applied to reset the photoelectric conversion portion 20 is equal to or more than the potential difference V_{A} (see FIG. 10) necessary to change the display state from the “on” state to the “off” state. In other words, in the image input/output device of the third embodiment, the reference voltage V_{REF} and the voltage V_{E} of the direct-current voltage source 40 are set such that the range of change of the voltage V_{LC} applied to the display layer 33 (display portion 30) is equal to V_{C} that is equal to or more than V_{A} shown in FIG. 10. Specifically, the reference voltage V_{REF} and the voltage V_{E} of the direct-current voltage source 40 are set such that the range of change of the voltage V_{LC} applied to the display layer 33 (display portion 30) corresponds to 0 to 5.5 volts.

In this way, it is possible to set the contrast of the display portion 30 at the highest contrast in the image input/output device of the third embodiment.

The other parts of the configuration of the image input/output device of the third embodiment are the same as in the first embodiment. The other effects of the third embodiment are also the same as those of the first embodiment.

### Fourth Embodiment

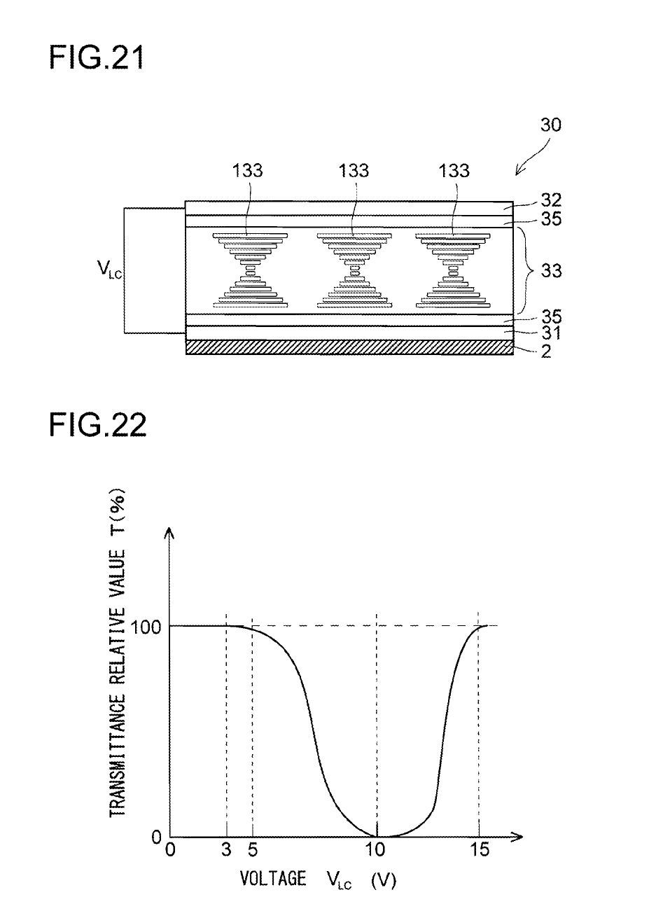

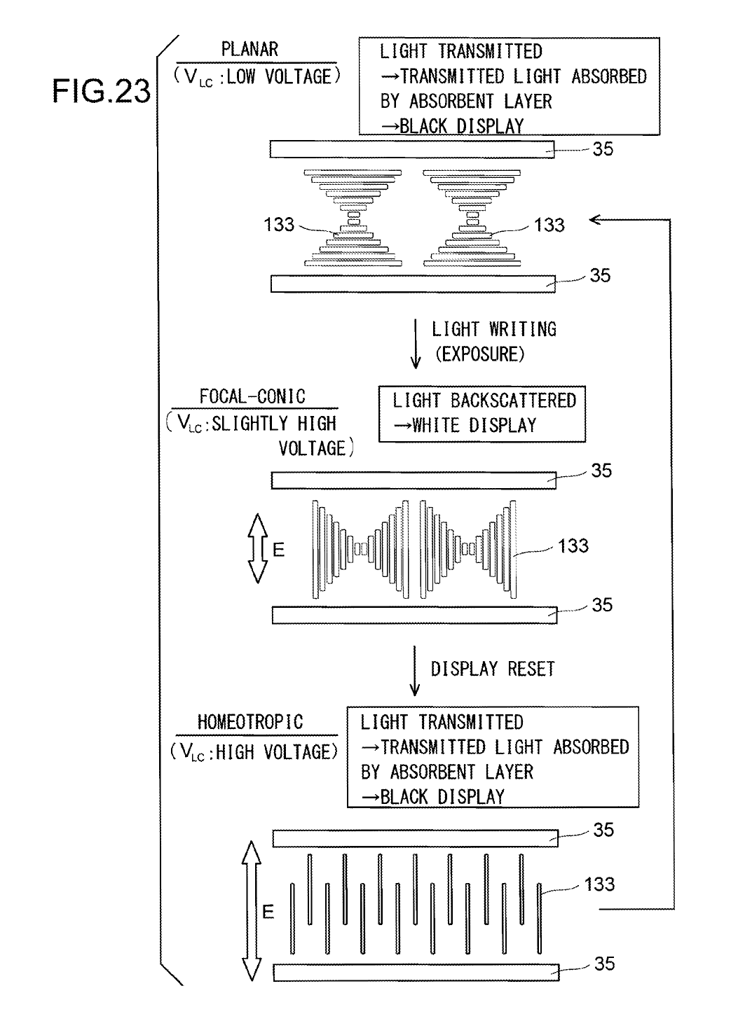

FIG. 21 is a schematic diagram showing the display element of the image input/output device according to the fourth embodiment of the present invention. FIG. 22 is a diagram showing the characteristic of the display element shown in FIG. 21. FIG. 23 is a diagram illustrating the display principle of the display element shown in FIG. 21. The image input/output device according to the fourth embodiment of the present invention will now be described with reference to FIGS. 3, 5 and 21 to 23.

The image input/output device of the fourth embodiment differs from those of the first to third embodiments in that the display layer 33 (see FIGS. 3 and 5) of the display element (display portion) 30 is formed of a chiral nematic liquid crystal composition. The chiral nematic liquid crystal composition is obtained by mixing a nematic liquid crystal material with a chiral agent. The chiral nematic liquid crystal has a helical structure in which the directions of alignment of its molecules are placed on each other while slightly twisted.

In the image input/output device of the fourth embodiment, as shown in FIG. 21, the display element (display portion) 30 is structured such that the display layer 33 including the chiral nematic liquid crystal 133 is sandwiched between the alignment film 35 and the display pixel electrode 31 and the display common electrode 32.

When the voltage V_{LC} is applied to the display layer 33 through the display pixel electrode 31 and the display common electrode 32, in the display layer 33 formed of the chiral nematic liquid crystal composition, the alignment of the chiral nematic liquid crystal 133 is varied according to the value of the voltage V_{LC} applied.

In the image input/output device of the fourth embodiment, the display element (display portion) 30 is adjusted to have a characteristic shown in FIG. 22. Specifically, the chiral nematic liquid crystal 133 is obtained by mixing the nematic liquid crystal (BL006; produced by Merck & Co., Inc.) with a chiral agent (CB15; produced by Merck & Co., Inc.). Here, the mixing ratio between the nematic liquid crystal and the chiral agent is set such that a selective reflection wavelength is 1000 nm, and is adjusted such that a transmissive state is produced when planar alignment occurs whereas scattering is produced when focal-conic alignment occurs. The display layer 33 is adjusted such that, when the voltage V_{C} ranges from 0 volts to about 3 volts, the planar alignment occurs, when the voltage V_{LC} is about 10 volts, the focal-conic alignment occurs and when the voltage V_{LC} is about 15 volts, homeotropic alignment occurs.

Hence, as shown in FIG. 23, when no voltage or a low voltage (for example, about 3 volts) is applied as the voltage V_{C} to the display layer 33, the chiral nematic liquid crystal 133 undergoes the planar alignment (its helical axis is perpendicular to the substrate plane), and thus the display layer 33 is brought into the transmissive state. Hence, the light that has entered the display layer 33 is transmitted through the display layer 33 and is absorbed by the light absorbent layer 2, and appears black (display is black). When a slightly higher voltage (for example, about 10 volts) is applied as the voltage V_{LC} to the display layer 33, the chiral nematic liquid crystal 133 changes from the planar alignment (its helical axis is perpendicular to the substrate plane) to the focal-conic alignment (its helical axis is parallel to the substrate plane). In the focal-conic alignment, the light that has entered the display layer 33 is backscattered, and thus appears white (display is white). When a high voltage (for example, about 15 volts) is applied as the voltage V_{LC} to the display layer 33, the chiral nematic liquid crystal 133 changes from the focal-conic alignment to the homeotropic alignment. In the homeotropic alignment, since the display layer 33 is brought into the transmissive state, the light that has entered the display layer 33 is transmitted through the display layer 33 and is absorbed by the light absorbent layer 2, and appears black (display is black). When, in this state, the application of the voltage is stopped, the alignment is changed to the planar alignment.

As described above, as the voltage V_{LC} applied to the display layer 33 is varied, the alignment of the chiral nematic liquid crystal 133 is varied, and thus the display state of the display element (display portion) 30 is changed. Even when no voltage is applied, the planar alignment and the focal-conic alignment are stable and are of memory characteristic. When an intermediate voltage is applied to the display layer 33, the planar alignment and the focal-conic alignment are mixed. Hence, in addition to two types of display, namely, white display and black display, gradation display is possible.

The other parts of the configuration of the fourth embodiment are the same as in the first to third embodiments.

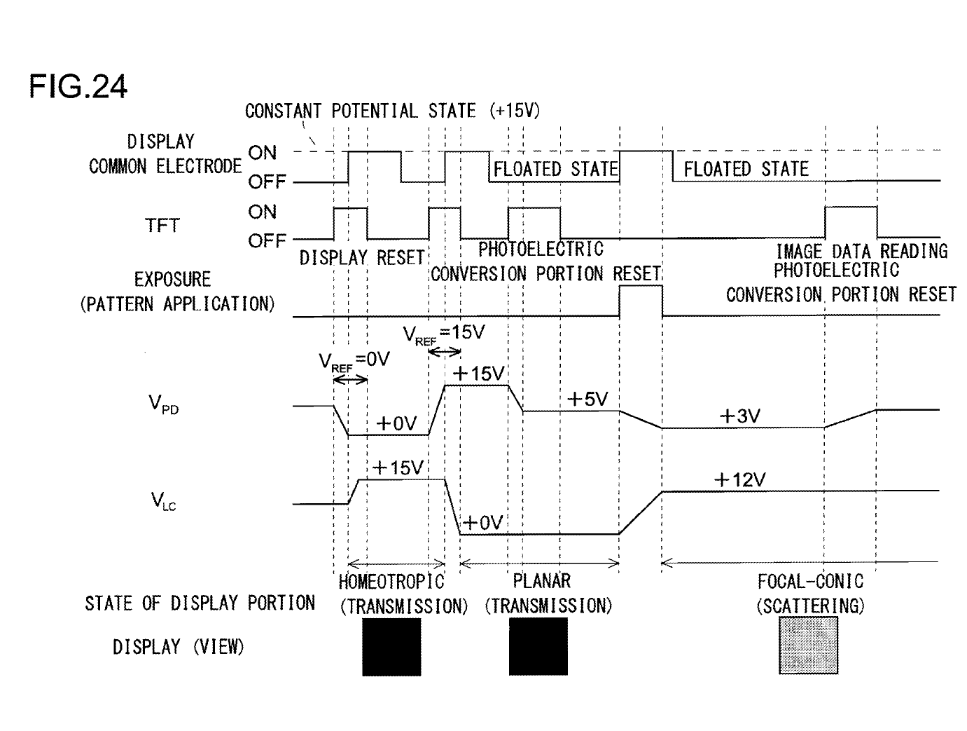

FIG. 24 is a timing chart illustrating the operation of the image input/output device according to the fourth embodiment of the present invention. The operation of the image input/output device according to the fourth embodiment of the present invention will be described with reference to FIGS. 1 to 3, 5 and 24. In the following description of the operation, a constant potential applied to the display common electrode 32 is assumed to be set at +15 volts.

As shown in FIG. 24, the TFT 10 (see FIG. 3) is first turned on, then the switch 41 (see FIG. 3) is turned on and the constant potential (+15 volts) is applied to the display common electrode 32. While the TFT 10 is kept on, a reference voltage V_{REF} of +0 volts is applied to the photoelectric conversion pixel electrode 22 (cathode electrode) (see FIG. 5) of the photoelectric conversion portion 20 (see FIGS. 3 and 5). Thus, the voltage V_{PD} applied to the photoelectric conversion portion (photodiode) 20 becomes +0 volts. Since the constant potential (+15 volts) is applied to the display common electrode 32, the voltage V_{LC} applied to the display portion 30 (display layer 33) becomes +15 volts, and the display portion 30 (display layer 33) undergoes the homeotropic alignment. Therefore, the display portion 30 (display layer 33) is brought into the transmissive state, and the display (view) turns black.

Thereafter, the switch 41 is turned off, the display common electrode 32 is floated and the homeotropic alignment is maintained.

In this state, the TFT 10 is turned on, then the switch 41 is turned on and the constant potential (+15 volts) is applied to the display common electrode 32. While the TFT 10 is kept on, the reference voltage V_{REF} of +15 volts is applied to the photoelectric conversion pixel electrode 22 (cathode electrode) of the photoelectric conversion portion 20. Thus, the voltage V_{PD} applied to the photoelectric conversion portion (photodiode) 20 becomes +15 volts, and the voltage V_{LC} applied to the display portion 30 becomes +0 volts. Hence, the display portion 30 (display layer 33) undergoes the planar alignment, and thus display portion 30 (display layer 33) is brought into the transmissive state, and the display (view) turns black. Consequently, the display of the display portion 30 is reset to the initial state.

Thereafter, the switch 41 is turned off, the display common electrode 32 is floated and the planar alignment is maintained.

Then, the TFT 10 is turned on, and thus a reference voltage V_{REF} of +5 volts is applied to the photoelectric conversion pixel electrode 22 (cathode electrode) of the photoelectric conversion portion 20. Thus, the voltage V_{PD} applied to the photoelectric conversion portion (photodiode) 20 becomes +5 volts. On the other hand, since the display common electrode 32 is in a floated state, the voltage V_{LC} applied to the display portion 30 remains the same (+0 volts). Consequently, the photoelectric conversion portion (photodiode) 20 is reset to the initial state.

Then, at the same time that the writing light, which is pattern light representing an image, is applied (exposure (pattern application), the switch 41 is turned on, and the image is written. Specifically, since the display portion 30 (display layer 33) undergoes the planar alignment, and is therefore in the transmissive state, the applied writing light is transmitted through the display portion 30 and is received by the photoelectric conversion portion 20. Inside the photoelectric conversion portion (photodiode) 20 that has received the writing light, electron-hole pairs are generated. Hence, charge stored in the photoelectric conversion portion (photodiode) 20 is reduced by the amount of charge corresponding to the generated electron-hole pairs. Thus, in a pixel, the voltage V_{PD} of the photoelectric conversion portion (photodiode) 20 is varied, for example, from +5 volts to +3 volts. Since the constant voltage (+15 volts) is maintained at the display common electrode 32 as a result of the switch 41 being turned on, the voltage V_{LC} of the display portion 30 (the corresponding display pixel) is varied from +0 volts to +12 volts as the voltage V_{PD} of the photoelectric conversion portion (photodiode) 20 is varied. In other words, the photoelectric conversion portion receives the pattern light, and thus the division of the voltage of the display portion 30 is changed. Hence, the display portion 30 is changed to approximate focal-conic alignment, and the transmittance is lowered. Therefore, scattering is produced, and the display turns whitish gray.

Since the writing light is applied to vary the display state of the display portion 30 of each pixel in this way, the image is written instantaneously. In other words, the application of the pattern light (exposure) representing an image allows the image corresponding to the pattern light (exposure pattern) to be instantaneously displayed on the display portion 30.

Then, the display common electrode 32 is floated by turning off the switch 41 with the image displayed. Thus, the image is continuously displayed.

After the application of the pattern light, scanning is performed to read image data on the written image. In the reading scanning, the switch 71c of the charge sensing amplifier 71 (see FIG. 3) is first turned off. Then, the scanning drive circuit 60 (see FIGS. 1 and 2) outputs a positive voltage to the scanning line 11, and thus the TFT 10 is turned on. By doing so, a current flows through the signal line 51 (see FIG. 3), and a voltage resulting from the charge-to-voltage conversion is output from the operational amplifier 71a (see FIG. 3). The voltage resulting from the charge-to-voltage conversion corresponds to the charge removed from the photoelectric conversion portion (photodiode) 20 at the time of the application of the pattern light. In this way, a pixel output signal (voltage) is read by the charge sensing amplifier 71 (see FIG. 3) in the column output circuit 70 (see FIG. 2). At the same time that the scanning is performed to read the image data, the photoelectric conversion portion (photodiode) 20 is reset to the initial state. Even when the scanning is performed to read the image data or the photoelectric conversion portion (photodiode) 20 is reset, unless the display portion 30 is reset, the display of the written image is maintained.

The pixel output signals read by the charge sensing amplifiers 71 (see FIGS. 2 and 3) are sequentially selected by the multiplexer 80 (see FIG. 2), are converted into serial electrical signals and are transmitted to the A-D converter 90 (see FIG. 2).

Then, the electrical signals transmitted from the multiplexer 80 are converted into digital data by the A-D converter 90.

This type of operation is performed on all the pixels, and thus image information on the written image is acquired as image data. Then, the acquired image data is recorded in the memory 110.

The operations such as the correlated double sampling processing are the same as in the first to third embodiments.

In the image input/output device of the fourth embodiment, since, as described above, the display layer 33 is formed of the chiral nematic liquid crystal composition and thus the display element (display portion) 30 has a memory characteristic, it is possible to hold an image displayed on the display portion 30 without power being supplied.

In the image input/output device of any of the first to third embodiments, its display memory time is about 10 minutes; by contrast, the image input/output device of the fourth embodiment (display element (display portion) 30) has a memory characteristic on a semipermanent basis. It is therefore possible to display a written image without power being supplied on a semipermanent basis.

The other effects of the fourth embodiment are the same as those of the first to third embodiments.

### Fifth Embodiment

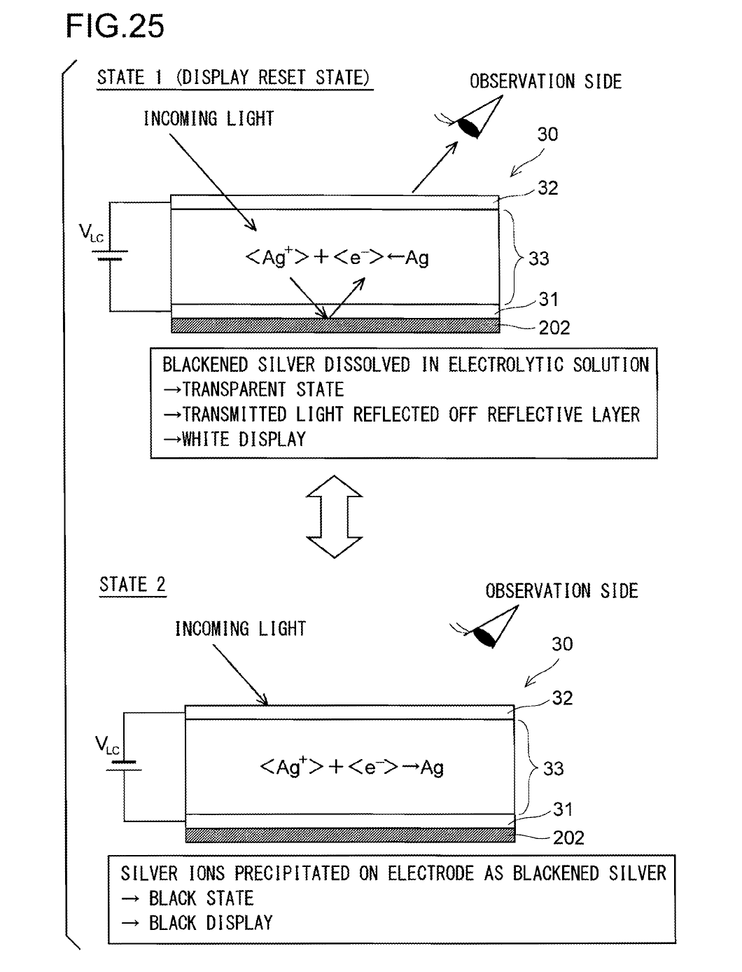

FIG. 25 is a diagram illustrating the display principle of the display element of the image input/output device according to the fifth embodiment of the present invention. The image input/output device according to the fifth embodiment of the present invention will now be described with reference to FIG. 25.

The image input/output device of the fifth embodiment differs from those of the first to fourth embodiments in that the display element (display portion) 30 is formed with an electrochemical reaction display element. Specifically, the display element (display portion) 30 of the fifth embodiment is formed with an ECD element utilizing the color change of an electrochromic material resulting from an oxidation-reduction reaction.

In the image input/output device of the fifth embodiment, the display element (display portion) 30 is structured such that the display layer 33 composed of an electrolyte layer having silver or a compound containing silver in its chemical structure is sandwiched between the display pixel electrode 31 and the display common electrode 32.

In the fifth embodiment, the electrolyte layer is formed of an electrolytic solution containing silver iodide. This electrolyte layer (display layer 33) can be produced as follows. 90 mg of sodium iodide and 75 mg of silver iodide are added and dissolved in 2.5 g of dimethylsulfoxide, then 150 mg of polyvinylpyrrolidone (having an average molecular weight of 15000) is added and the resulting solution is stirred for one hour while being heated to 120° C., with the result that the electrolytic solution containing silver iodide can be produced.

In the fifth embodiment, when seen from the observation side, instead of the light absorbent layer, a light reflective layer 202 is arranged (formed) on the back surface side of the display layer 33.

When the voltage V_{LC} is applied through the display pixel electrode 31 and the display common electrode 32 to the display layer 33, an oxidation-reduction reaction of silver occurs on the display pixel electrode 31 and the display common electrode 32. Thus, it is possible to reversibly switch between a blackened silver image in a reduced state and transparent silver in an oxidized state by controlling the value of the applied voltage V_{LC}.

Specifically, in state 1 shown in FIG. 25, the blackened silver is dissolved in the solution and is therefore transparent. Hence, light incident from the observation side is transmitted through the display layer 33. The transmitted light is reflected off the light reflective layer 202 and thus appears white (display is white). This state is referred to as a display reset state.

On the other hand, in state 2 shown in FIG. 25, silver ions are precipitated on the electrode (display common electrode 32) as the blackened silver, and are turned black. Hence, they appear black (display is black).

As described above, since the variation of the voltage V_{LC} applied to the display layer 33 causes the oxidation-reduction reaction of silver, the display state of the display element (display portion) 30 is varied. Thus, an image is displayed on the display portion 30.

The other parts of the configuration of the fifth embodiment are the same as in the first to fourth embodiments.

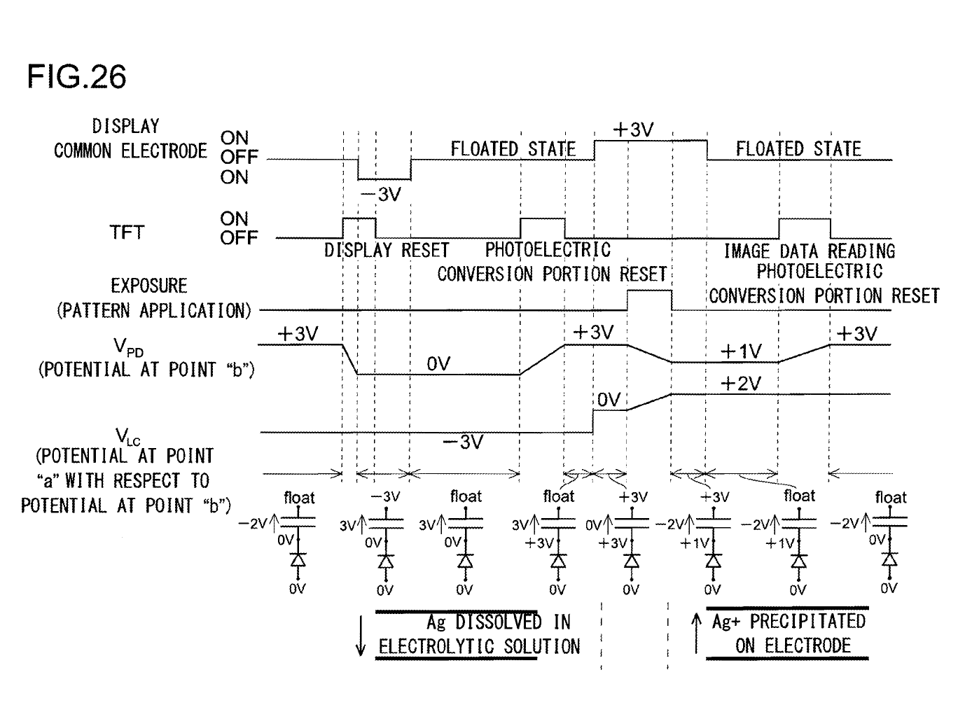

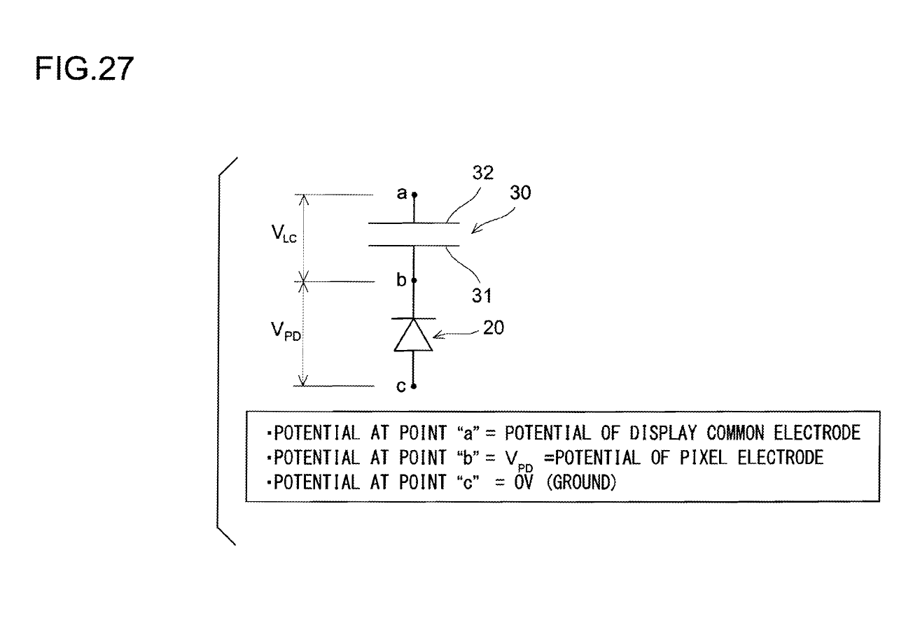

FIG. 26 is a timing chart illustrating the operation of the image input/output device according to the fifth embodiment of the present invention. FIG. 27 is a diagram illustrating a potential applied to the photoelectric conversion portion and the display portion. The operation of the image input/output device according to the fifth embodiment of the present invention will be described with reference to FIGS. 1 to 3, 5, 26 and 27.

In the description of the operation of the fifth embodiment, as shown in FIG. 27, the potential of the display common electrode 32 is assumed to be a potential at point “a”, the potential of the pixel electrode is assumed to be a potential at point “b” and the potential of the anode electrode of the photoelectric conversion portion (photodiode) 20 is assumed to be a potential at point “c”. Since the anode electrode is grounded, the potential at point “c” is 0 volts. Hence, the potential at point “b” is assumed to be the voltage V_{PD} (voltage applied across the photoelectric conversion portion 20) of the photoelectric conversion portion (photodiode) 20, and the potential at point “a” with respect to the potential at point “b” is assumed to be the voltage V_{LC} (voltage applied across the display portion 30) of the display portion 30.

As shown in FIG. 26, the TFT 10 (see FIG. 3) is first turned on, then the switch 41 (see FIG. 3) is turned on and thus a constant potential (−3 volts) is applied to the display common electrode 32 (point “a”). When the TFT 10 is turned on, a reference voltage V_{REF} (0 volts) is applied to the photoelectric conversion pixel electrode 22 (cathode electrode) (point “b”) (see FIG. 5) of the photoelectric conversion portion 20 (see FIGS. 3 and 5). Thus, the voltage V_{PD} (potential at point “b”) applied to the photoelectric conversion portion (photodiode) 20 becomes 0 volts. Since the constant voltage (−3 volts) is applied to the display common electrode 32 (point “a”), the voltage V_{LC} applied to the display portion 30 becomes −3 volts, and thus Ag (silver) is dissolved in the electrolytic solution and the transparent state is produced. Consequently, the display (view) turns white, and the display of the display portion 30 is rest to the initial state.

Then, the switch 41 is turned off, and the display common electrode 32 (point “a”) is floated.

Then, the TFT 10 is turned on, and a reference voltage V_{REF} (+3 volts) is applied to the photoelectric conversion pixel electrode 22 (cathode electrode) (point “b”) of the photoelectric conversion portion 20. Thus, the voltage V_{PD} applied to the photoelectric conversion portion (photodiode) 20 becomes +3 volts, and the photoelectric conversion portion (photodiode) 20 is reset to the initial state. On the other hand, since the display common electrode 32 (point “a”) (see FIG. 27) is in a floated state, the voltage V_{LC} applied to the display portion 30 remains the same (−3 volts).

Thereafter, the switch 41 is turned on, and the constant voltage (+3 volts) is applied to the display common electrode 32 (point “a”). Thus, the voltage V_{LC} applied to the display portion 30 becomes 0 volts.

In this state, the writing light, which is pattern light representing an image, is applied (exposure (pattern application)), and thus the image is written. Specifically, since the display portion 30 is in the transparent state, the writing light applied is transmitted through the display portion 30 and is received by the photoelectric conversion portion 20. Inside the photoelectric conversion portion (photodiode) 20 that has received the writing light, electron-hole pairs are generated. Hence, charge stored in the photoelectric conversion portion (photodiode) 20 is reduced by the amount of charge corresponding to the generated electron-hole pairs. Thus, in a pixel, the voltage V_{PD} of the photoelectric conversion portion (photodiode) 20 is varied, for example, from +3 volts to +1 volt. Since the constant voltage (+3 volts) is maintained at the display common electrode 32 (point “a”) as a result of the switch 41 being turned on, the voltage V_{LC} of the display portion 30 (the corresponding display pixel) is varied from 0 volts to +12 volts as the voltage V_{PD} of the photoelectric conversion portion (photodiode) 20 is varied. In this way, silver ions in the display layer 33 (electrolyte layer) are precipitated on the electrode (display common electrode 32) as the blackened silver, and are turned black.

Since the writing light is applied to vary the display state of the display portion 30 of each pixel in this way, the image is written instantaneously. In other words, the application of the pattern light (exposure) representing an image allows the image corresponding to the pattern light (exposure pattern) to be instantaneously displayed on the display portion 30.

Then, with the image displayed, the switch 41 is turned off, and the display common electrode 32 (point “a”) is switched to the floated state. Thus, the image is continuously displayed.

After the application of the pattern light, scanning is performed to read image data on the written image. In the reading scanning, the switch 71c of the charge sensing amplifier 71 (see FIG. 3) is first turned off. Then, the scanning drive circuit 60 (see FIGS. 1 and 2) outputs a positive voltage to the scanning line 11, and thus the TFT 10 is turned on. By doing so, a current flows through the signal line 51 (see FIG. 3), and a voltage resulting from the charge-to-voltage conversion is output from the operational amplifier 71a (see FIG. 3). The voltage resulting from the charge-to-voltage conversion corresponds to the charge removed from the photoelectric conversion portion (photodiode) 20 at the time of the application of the pattern light. In this way, a pixel output signal (voltage) is read by the charge sensing amplifier 71 (see FIG. 3) in the column output circuit 70 (see FIG. 2). At the same time that the scanning is performed to read the image data, the photoelectric conversion portion (photodiode) 20 is reset to the initial state. Even when the scanning is performed to read the image data or the photoelectric conversion portion (photodiode) 20 is reset, unless the display portion 30 is reset, the display of the written image is maintained.

The pixel output signals read by the charge sensing amplifiers 71 (see FIGS. 2 and 3) are sequentially selected by the multiplexer 80 (see FIG. 2), are converted into serial electrical signals and are transmitted to the A-D converter 90 (see FIG. 2).

Then, the electrical signals transmitted from the multiplexer 80 are converted into digital data by the A-D converter 90.

This type of operation is performed on all the pixels, and thus image information on the written image is acquired as image data. Then, the acquired image data is recorded in the memory 110.

The operations such as the correlated double sampling processing are the same as in the first to fourth embodiments.

In the image input/output device of the fifth embodiment, since, as described above, the display element (display portion) 30 is formed with the electrochemical reaction display element and thus the display element (display portion) 30 has a memory characteristic, it is possible to hold an image displayed on the display portion 30 without power being supplied.

In the fifth embodiment, since the display element (display portion) 30 is formed with the electrochemical reaction display element, it is possible to drive it with a low voltage of 3 volts. Consequently, it is possible to obtain an excellent display quality (bright paper-like white and strong black).

The other effects of the fifth embodiment are the same as those of the first to fourth embodiments.

### Sixth Embodiment

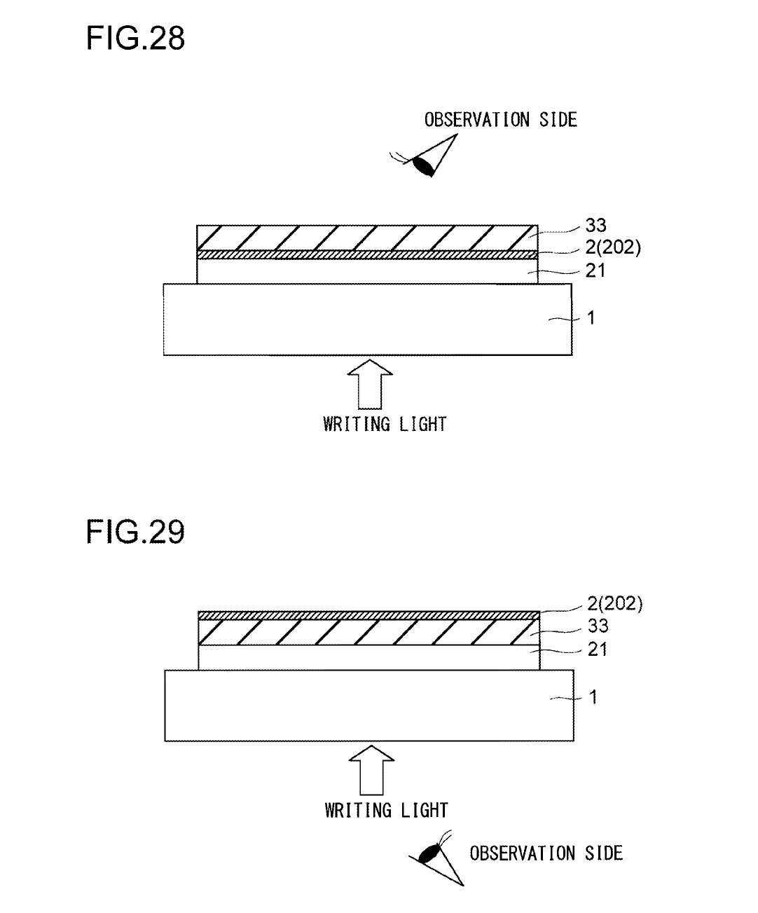

FIG. 28 is a diagram schematically showing the configuration of an image input/output device according to a sixth embodiment of the present invention. The image input/output device according to the sixth embodiment of the present invention will now be described with reference to FIG. 28.

The image input/output device (pixel array portion) of the sixth embodiment is the same as those of the first to fifth embodiments in that the photoelectric conversion layer 21 and the display layer 33 are sequentially formed on the substrate (first substrate) 1 from the side of the first substrate 1. The image input/output device (pixel array portion) of the sixth embodiment is configured that the upper surface side (front surface side) of the substrate 1 is the observation side.

On the other hand, in the sixth embodiment, the writing light, which is pattern light representing an image, is applied from the lower surface side (back surface side) of the substrate 1. In other words, in the sixth embodiment, exposure is performed from the opposite side to the observation side. Moreover, in the sixth embodiment, the light absorbent layer 2 (or the light reflective layer 202) is formed between the photoelectric conversion layer 21 and the display layer 33.

As in the first to fifth embodiments, when seen from the observation side, the light absorbent layer 2 (or the light reflective layer 202) is arranged (formed) on the back surface side of the display layer 33.

The other parts of the configuration of the image input/output device of the sixth embodiment are the same as in the first to fifth embodiments. The effects of the image input/output device according to the sixth embodiment are also the same as those of the first to fifth embodiments.

FIG. 29 is a diagram schematically showing the configuration of an image input/output device of a first variation of the sixth embodiment. As shown in FIG. 29, in the image input/output device (pixel array portion) of the first variation of the sixth embodiment, the lower surface side (back surface side) of the substrate (first substrate) 1 is the observation side.

As in the sixth embodiment, the writing light, which is pattern light representing an image, is applied from the lower surface side (back surface side) of the substrate 1. In other words, in the first variation of the sixth embodiment, exposure is performed from the same side as the observation side.

On the other hand, in the first variation of the sixth embodiment, the light absorbent layer 2 (or the light reflective layer 202) is formed on the upper surface (on the surface opposite the photoelectric conversion layer 21) of the display layer 33. Even in this case, when seen from the observation side, the light absorbent layer 2 (or the light reflective layer 202) is arranged (formed) on the back surface side of the display layer 33.

The other parts of the configuration of the image input/output device according to the first variation of the sixth embodiment are the same as in the first to fifth embodiments. The effects of the image input/output device according to the first variation of the sixth embodiment are also the same as in the first to fifth embodiments.

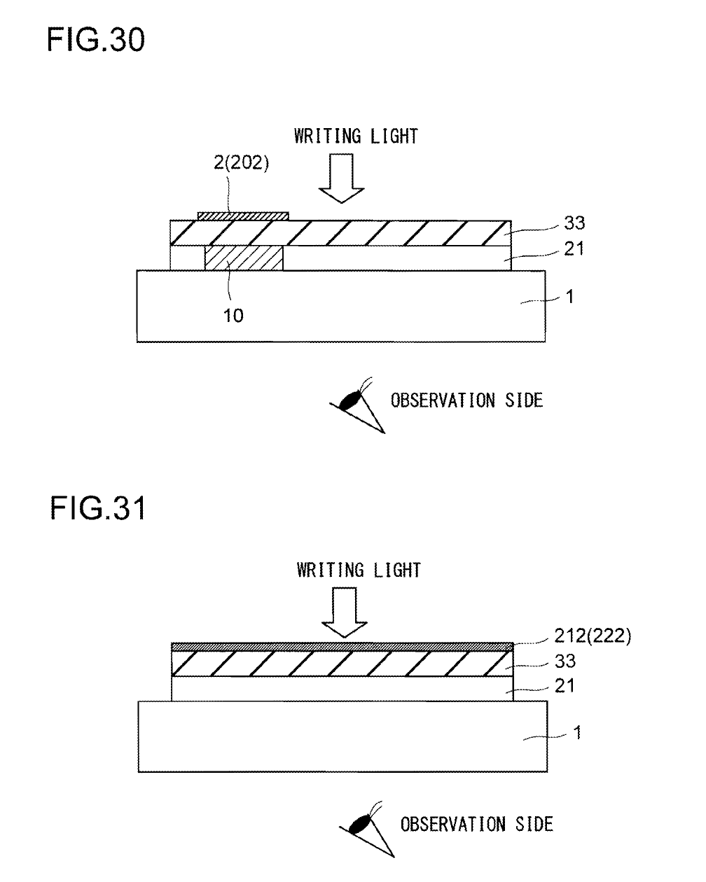

FIG. 30 is a diagram schematically showing the configuration of an image input/output device of a second variation of the sixth embodiment. As shown in FIG. 30, in the image input/output device (pixel array portion) of the second variation of the sixth embodiment, the lower surface side (back surface side) of the substrate (first substrate) 1 is the observation side.

As in the first to fifth embodiments, the writing light, which is pattern light representing an image, is applied from the upper surface side (front surface side) of the substrate 1. In other words, in the second variation of the sixth embodiment, exposure is performed from the side opposite the observation side.

In the second variation of the sixth embodiment, on a region that is located on the upper surface (on the surface opposite the photoelectric conversion layer 21) of the display layer 33 and that corresponds to the TFT 10, the light absorbent layer 2 (or the light reflective layer 202) is formed. In other words, the light absorbent layer 2 (or the light reflective layer 202) is formed on the upper surface of the display layer 33 so as to cover the TFT 10. Thus, the writing light is prevented from being applied to the TFT 10. As described above, when seen from the observation side, the light absorbent layer 2 (or the light reflective layer 202) is arranged (formed) on the back surface side of the display layer 33.

The other parts of the configuration of the image input/output device according to the second variation of the sixth embodiment are the same as in the first to fifth embodiments.

In the second variation of the sixth embodiment, since the above configuration is employed, it is possible to prevent light from being shone on the TFT 10. Thus, it is possible to prevent the characteristic of the TFT 10 from being deteriorated as a result of a light leak current being produced.

The other effects of the image input/output device according to the second variation of the sixth embodiment are the same as in the first to fifth embodiments.

FIG. 31 is a diagram schematically showing the configuration of an image input/output device according to a third variation of the sixth embodiment. As shown in FIG. 31, the image input/output device (pixel array portion) of the third variation of the sixth embodiment differs from that of the second variation of the sixth embodiment in that, instead of the light absorbent layer (or the light reflective layer), a semi-absorbent, semi-transmissive layer 212 (or semi-reflective, semi-transmissive layer 222) is formed. The semi-absorbent, semi-transmissive layer 212 (or the semi-reflective, semi-transmissive layer 222) is formed on a substantially entire upper surface (on the surface opposite the photoelectric conversion layer 21) of the display layer 33.

The other parts of the configuration of the image input/output device according to the third variation of the sixth embodiment are the same as in the second variation of the sixth embodiment.

The other effects of the image input/output device according to the third variation of the sixth embodiment are the same as in the second variation of the sixth embodiment.

### Seventh Embodiment

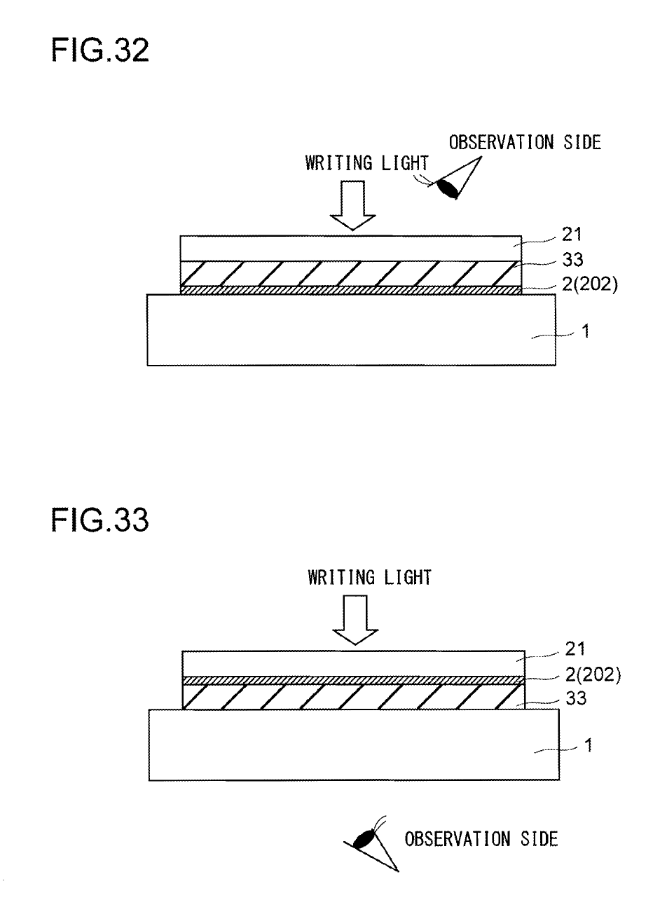

FIG. 32 is a diagram schematically showing the configuration of an image input/output device according to a seventh embodiment of the present invention. The image input/output device according to the seventh embodiment of the present invention will now be described with reference to FIG. 32.

The image input/output device (pixel array portion) of the seventh embodiment is configured such that the display layer 33 and the photoelectric conversion layer 21 are sequentially formed on the substrate (first substrate) 1 from the side of the first substrate 1. The image input/output device (pixel array portion) of the seventh embodiment is configured that the upper surface side (front surface side) of the substrate 1 is the observation side.

As in the first to fifth embodiments, in the seventh embodiment, the writing light, which is pattern light representing an image, is applied from the upper surface side (front surface side) of the substrate 1. In other words, exposure is performed from the same side as the observation side. Moreover, in the seventh embodiment, the light absorbent layer 2 (or the light reflective layer 202) is formed between the substrate 1 and the display layer 33.

As in the first to sixth embodiments, when seen from the observation side, the light absorbent layer 2 (or the light reflective layer 202) is arranged (formed) on the back surface side of the display layer 33.

The other parts of the configuration of the image input/output device according to the seventh embodiment are the same as in the first to fifth embodiments. The effects of the image input/output device of the seventh embodiment are also the same as in the first to fifth embodiments.

FIG. 33 is a diagram schematically showing the configuration of an image input/output device according to a first variation of the seventh embodiment. As shown in FIG. 33, in the image input/output device (pixel array portion) according to the first variation of the seventh embodiment, the lower surface side (back surface side) of the substrate (first substrate) 1 is the observation side.

As in the seventh embodiment, the writing light, which is pattern light representing an image, is applied from the upper surface side (front surface side) of the substrate 1. In other words, in the first variation of the seventh embodiment, exposure is performed from the opposite side to the observation side.

In the first variation of the seventh embodiment, the light absorbent layer 2 (or the light reflective layer 202) is formed between the photoelectric conversion layer 21 and the display layer 33. Even in this case, when seen from the observation side, the light absorbent layer 2 (or the light reflective layer 202) is arranged (formed) on the back surface side of the display layer 33.

The other parts of the configuration of the image input/output device according to the first variation of the seventh embodiment are the same as in the first to fifth embodiments. The effects of the image input/output device according to the first variation of the seventh embodiment are also the same as in the first to fifth embodiments.

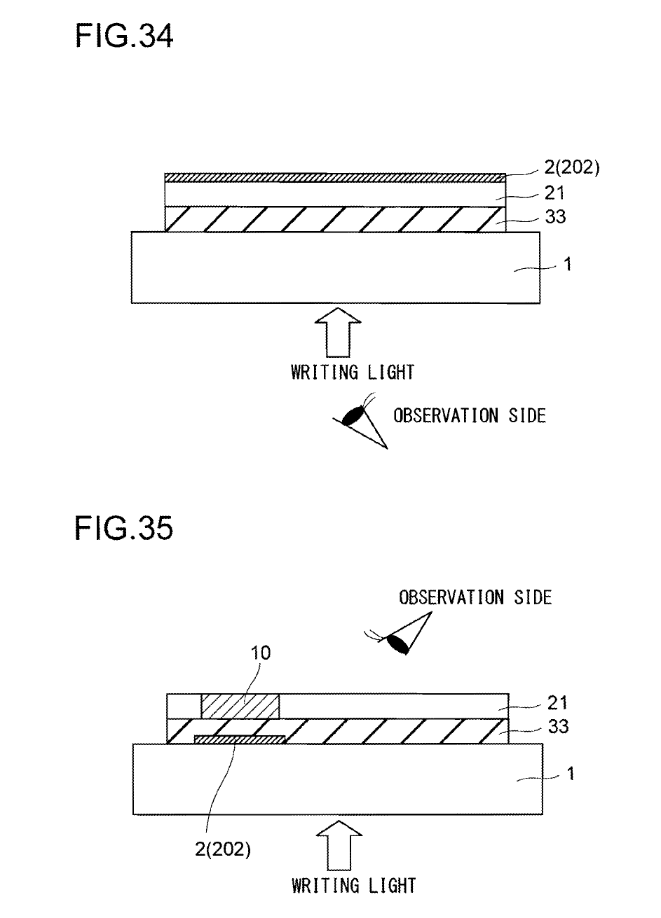

FIG. 34 is a diagram schematically showing the configuration of an image input/output device according to a second variation of the seventh embodiment. As shown in FIG. 34, in the image input/output device (pixel array portion) according to the second variation of the seventh embodiment, the lower surface side (back surface side) of the substrate (first substrate) 1 is the observation side.

The writing light, which is pattern light representing an image, is applied from the lower surface side (back surface side) of the substrate 1. In other words, in the second variation of the seventh embodiment, exposure is performed from the same side as the observation side.

In the second variation of the seventh embodiment, on the upper surface of the photoelectric conversion layer 21 (on the surface opposite the display layer 33), the light absorbent layer 2 (or the light reflective layer 202) is formed. As described above, when seen from the observation side, the light absorbent layer 2 (or the light reflective layer 202) is arranged (formed) on the back surface side of the display layer 33.

The other parts of the configuration of the image input/output device according to the second variation of the seventh embodiment are the same as in the first to fifth embodiments. The effects of the image input/output device according to the second variation of the seventh embodiment are also the same as in the first to fifth embodiments.

FIG. 35 is a diagram schematically showing the configuration of an image input/output device according to a third variation of the seventh embodiment. As shown in FIG. 35, in the image input/output device (pixel array portion) according to the third variation of the seventh embodiment, the upper surface side (front surface side) of the substrate (first substrate) 1 is the observation side.

The writing light, which is pattern light representing an image, is applied from the lower surface side (back surface side) of the substrate 1. In other words, in the third variation of the seventh embodiment, exposure is performed from the opposite side to the observation side.

In the third variation of the seventh embodiment, in a region that is located between the first substrate 1 and the display layer 33 and that corresponds to the TFT 10, the light absorbent layer 2 (or the light reflective layer 202) is formed. Thus, the writing light is prevented from being applied to the TFT 10. As described above, when seen from the observation side, the light absorbent layer 2 (or the light reflective layer 202) is arranged (formed) on the back surface side of the display layer 33.

The other parts of the configuration of the image input/output device according to the third variation of the seventh embodiment are the same as in the first to fifth embodiments.

In the third variation of the seventh embodiment, since the above configuration is employed, it is possible to prevent light from being shone on the TFT 10. Thus, it is possible to prevent the characteristic of the TFT 10 from being deteriorated as a result of a light leak current being produced.

The other effects of the image input/output device according to the third variation of the seventh embodiment are the same as in the first to fifth embodiments.

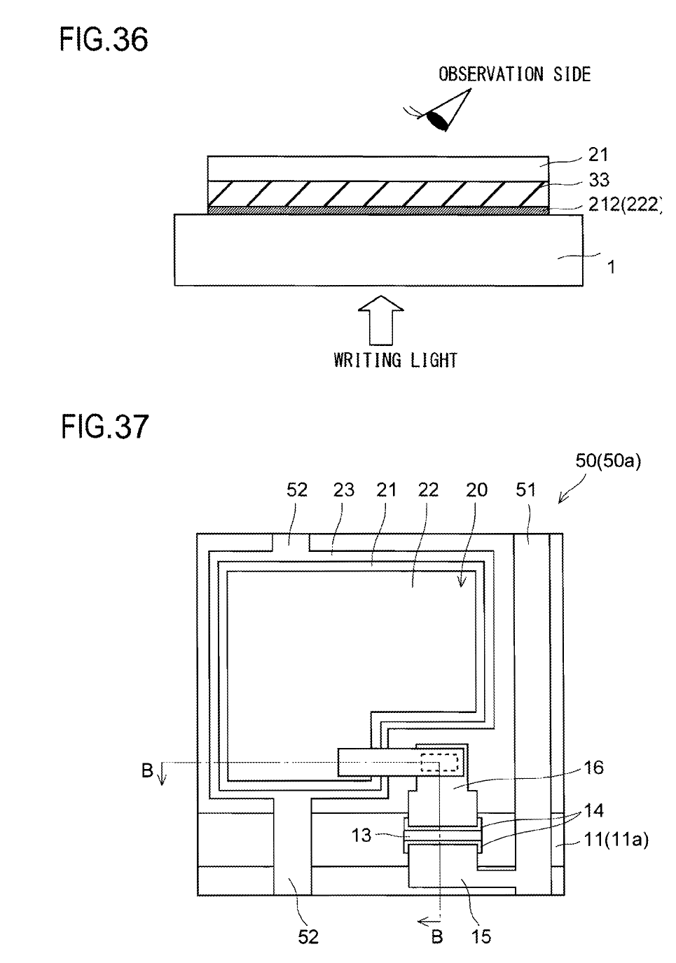

FIG. 36 is a diagram schematically showing the configuration of an image input/output device according to a fourth variation of the seventh embodiment. As shown in FIG. 36, the image input/output device (pixel array portion) according to the fourth variation of the seventh embodiment differs from that according to the third variation of the seventh embodiment in that, instead of the light absorbent layer (or the light reflective layer), the semi-absorbent, semi-transmissive layer 212 (or the semi-reflective, semi-transmissive layer 222) is formed. The semi-absorbent, semi-transmissive layer 212 (or the semi-reflective, semi-transmissive layer 222) is formed on a substantially entire surface of the display layer 33 between the substrate 1 and the display layer 33.

The other parts of the configuration of the image input/output device according to the forth variation of the seventh embodiment are the same as in the third variation of the seventh embodiment.

The effects of the image input/output device according to the fourth variation of the seventh embodiment are also the same as in the third variation of the seventh embodiment.

### Eighth Embodiment

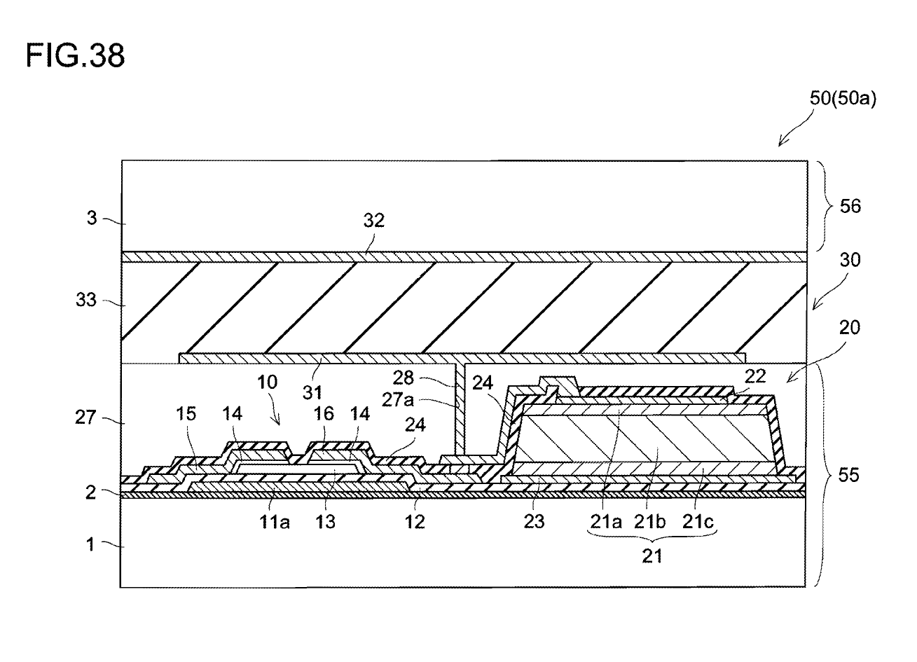

FIG. 37 is a plan view showing part of the pixel array portion of an image input/output device according to an eighth embodiment of the present invention. FIG. 38 is a cross-sectional view taken along line B-B of FIG. 37. While the display portion and the like are omitted in FIG. 37, the omitted portions are shown in FIG. 38. FIGS. 37 and 38 show the structure of one pixel in the pixel array portion. The image input/output device (pixel array portion) according to the eighth embodiment of the present invention will now be described with reference to FIGS. 37 to 38.

As shown in FIGS. 37 and 38, the image input/output device (pixel array portion) according to the eighth embodiment of the present invention differs from those of the first to fifth embodiments in that the TFT 10 and the photoelectric conversion portion 20 are configured in a bias top structure. Specifically, in the eighth embodiment, the photoelectric conversion pixel electrode 22 of the photoelectric conversion portion 20 is arranged on the opposite side to the first substrate 1 with respect to the photoelectric conversion layer 21; the photoelectric conversion common electrode 23 of the photoelectric conversion portion 20 is arranged on the side of the first substrate 1 with respect to the photoelectric conversion layer 21. The drain electrode 16 of the TFT 10 and the photoelectric conversion pixel electrode 22 of the photoelectric conversion portion 20 are electrically connected to each other through the display portion 28.

In the eight embodiment, the photoelectric conversion layer 21 is formed by sequentially depositing the P-type amorphous silicon layer 21c, the I-type amorphous silicon layer 21b and the N-type amorphous silicon layer 21a from the side of the first substrate 1 (the side of the photoelectric conversion common electrode 23).

The other parts of the configuration of the image input/output device according to the eighth embodiment are the same as in the first to fifth embodiments.

The effects of the image input/output device according to the eighth embodiment are the same as in the first to fifth embodiments.

### Ninth Embodiment

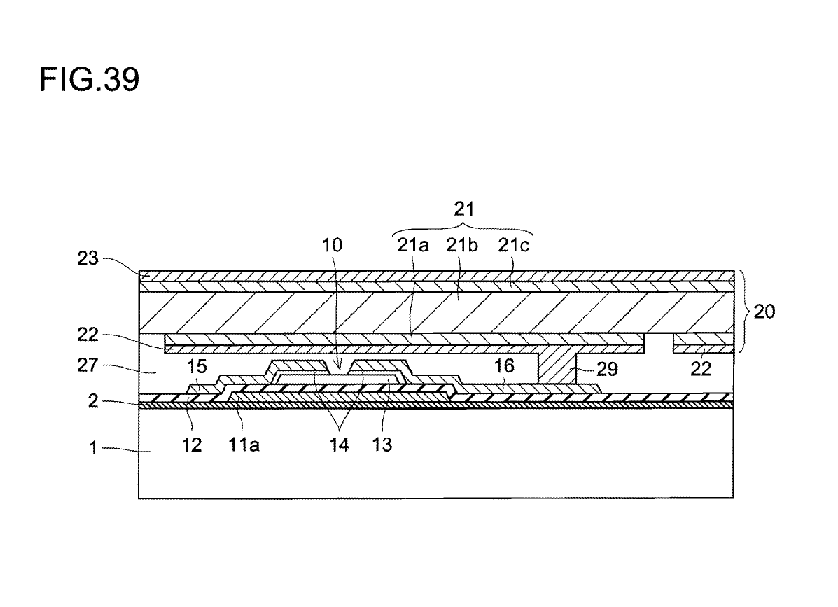

FIG. 39 is a cross-sectional view showing part of the pixel array portion of an image input/output device according to a ninth embodiment of the present invention. The image input/output device (pixel array portion) according to the ninth embodiment of the present invention will now be described with reference to FIG. 39.

The image input/output device (pixel array portion) of the ninth embodiment differs from those of the first to fifth embodiments in that the TFT 10 and the photoelectric conversion portion 20 are arranged in a stack structure. Specifically, in the ninth embodiment, the photoelectric conversion portion 20 is formed above the TFT 10 formed on the first substrate 1. In the photoelectric conversion portion 20, the photoelectric conversion pixel electrode 22, the photoelectric conversion layer 21 and the photoelectric conversion common electrode 23 are sequentially formed from the side of the TFT 10. The photoelectric conversion layer 21 is formed with a PIN photoelectric conversion film obtained by sequentially depositing, from the side of the photoelectric conversion pixel electrode 22, the N-type amorphous silicon layer 21a, the I-type amorphous silicon layer 21b and the P-type amorphous silicon layer 21c. The drain electrode 16 of the TFT 10 and the photoelectric conversion pixel electrode 22 of the photoelectric conversion portion 20 are electrically connected to each other through a connection wiring 29.

The other parts of the configuration of the image input/output device according to the ninth embodiment are the same as in the first to fifth embodiments.

The effects of the image input/output device of the ninth embodiment are also the same as in the first to fifth embodiments.

### Tenth Embodiment

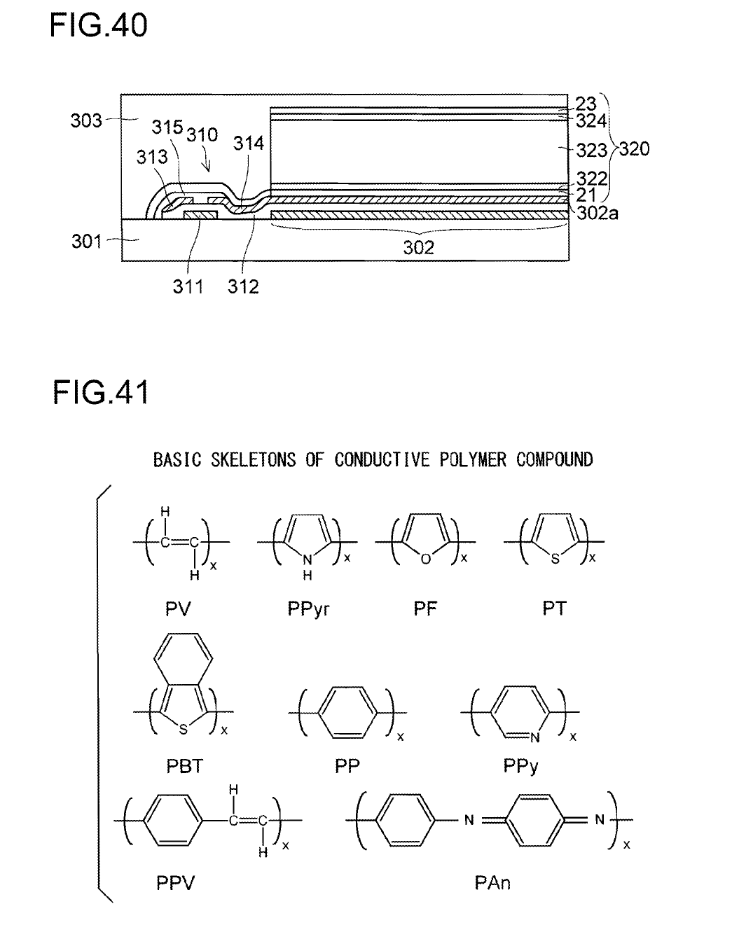

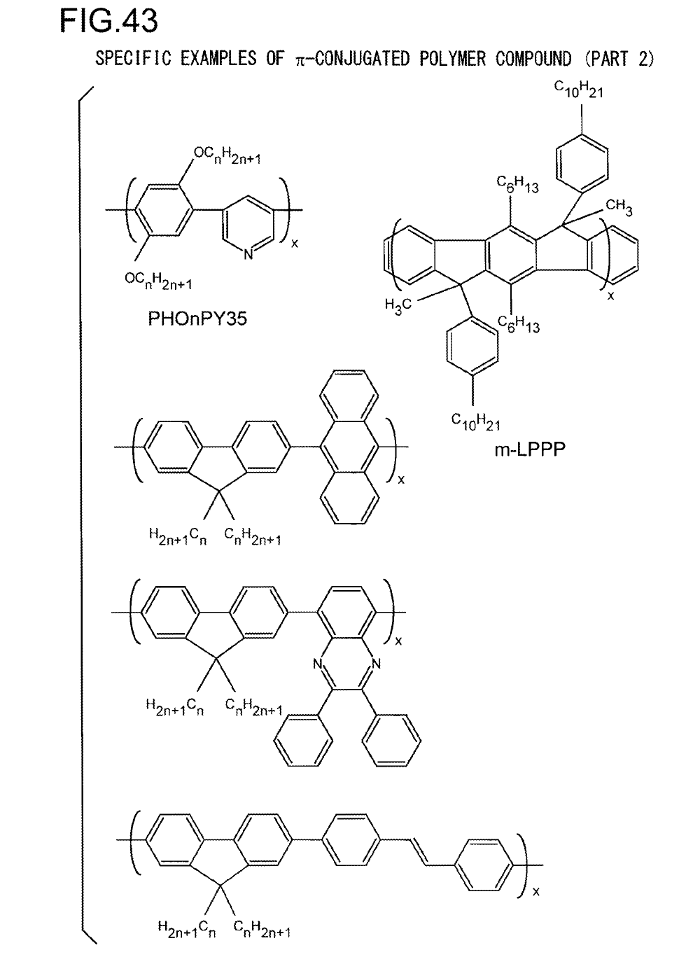

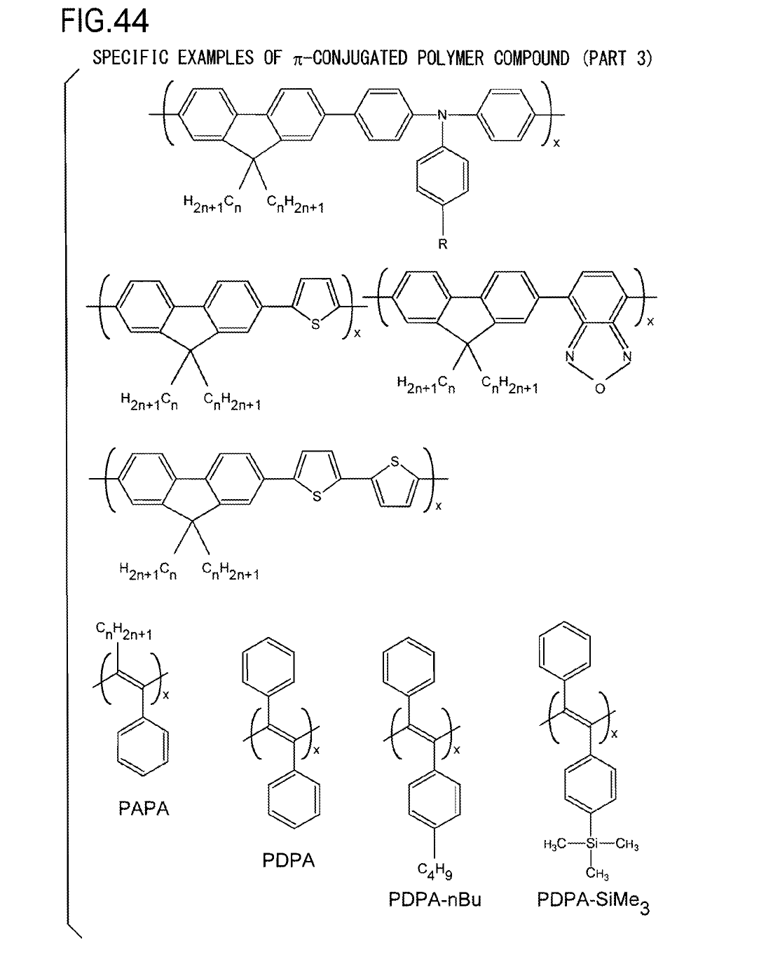

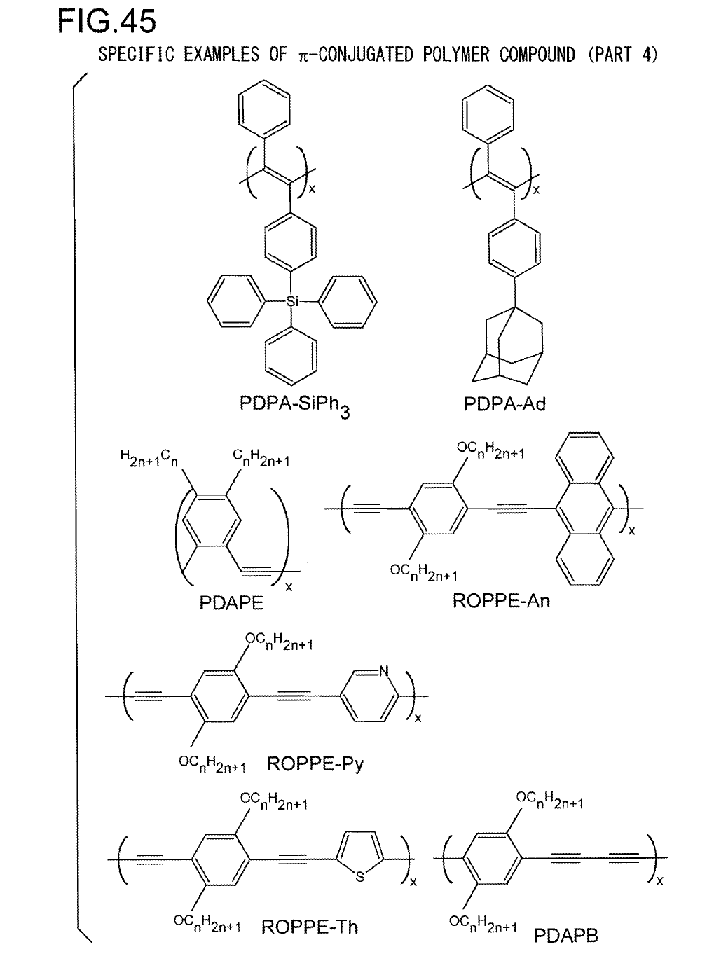

FIG. 40 is a cross-sectional view showing part of the pixel array portion of an image input/output device according to a tenth embodiment of the present invention. FIGS. 41 to 47 are diagrams showing specific examples of constituent materials of which the photoelectric conversion portion 20 is formed. The image input/output device according to the tenth embodiment of the present invention will now be described with reference to FIGS. 40 to 47. In FIG. 40, the light absorbent layer, the light reflective layer and the semi-absorbent, semi-transmissive layer or the semi-reflective, semi-transmissive layer are omitted.

The image input/output device (pixel array portion) of the tenth embodiment includes an organic TFT 310 formed of organic semiconductor and a photoelectric conversion portion 320 formed of organic semiconductor. The organic TFT 310 is an example of the “switching element” of the present invention.

As shown in FIG. 40, the organic TFT 310 is configured by sequentially forming on a substrate 301a gate electrode 311, an insulation layer 312, a source electrode 313/a drain electrode 314 and an organic semiconductor layer 315 from the substrate 301. The photoelectric conversion portion 320 is configured by sequentially forming on the substrate 301 the photoelectric conversion pixel electrode 22, a hole block layer 322, a photoelectric conversion layer 323, an electron block layer 324 and the photoelectric conversion common electrode 23 from the side of the substrate 301. An unillustrated bias wiring layer is electrically connected to the photoelectric conversion common electrode 23.

On the other hand, on the side of the lower layer of the photoelectric conversion portion 320, a capacitor 302 for storing electrical energy is provided in each pixel. The photoelectric conversion pixel electrode 22 of the photoelectric conversion portion 320 is electrically connected to the drain electrode 314 of the organic TFT 310 through a collection electrode 302a serving as one of the electrodes of the capacitor 302. Thus, the organic TFT 310 and the photoelectric conversion portion 320 are configured in a bias top structure.

On the upper surface of the substrate 301, a planarization film 303 is formed to cover the organic TFT 310 and the photoelectric conversion portion 320. An unillustrated display pixel electrode is formed on the planarization film 303; this display pixel electrode and the photoelectric conversion pixel electrode 22 are electrically connected to each other through a connection wiring (unillustrated).

The configuration of a so-called organic EL element can be applied to the photoelectric conversion layer 323 of the photoelectric conversion portion 320. An organic EL element formed of low-molecular constituent material or an organic EL element formed of high-molecular constituent material (also called light-emitting polymer) may be used. Examples of the material used in the photoelectric conversion layer 323 of the tenth embodiment and capable of photoelectric conversion include a conductive polymer material (such as a π-conjugated polymer material) and a light-emitting material used in a low-molecular organic EL element. Examples of the conductive polymer material include poly(2-methoxy, 5-(2′-ethylhexyloxy)-p-phenylenevinylene and poly(3-alkylthiophenes). The examples also include compounds described in pages 190 to 203 of a book entitled “Organic EL Material and Display (published on Feb. 28, 2001 by CAC Company Ltd.)” and compounds described in pages 81 to 99 of a book entitled “Organic EL Element and its Frontier of Industrialization (published on Nov. 30, 1998 by NTS Company Ltd.).”

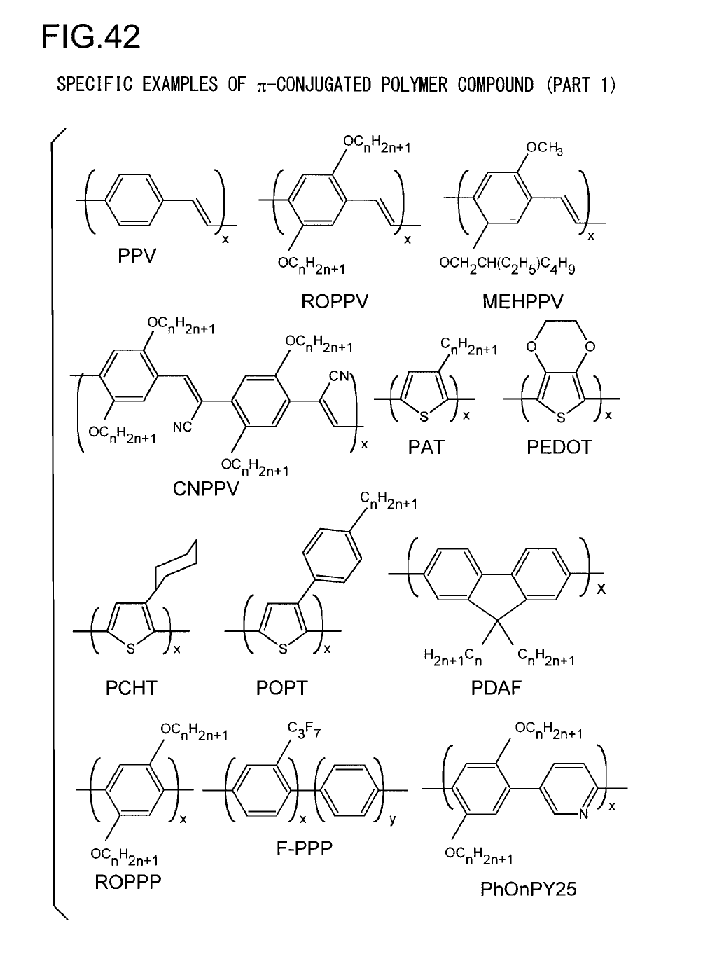

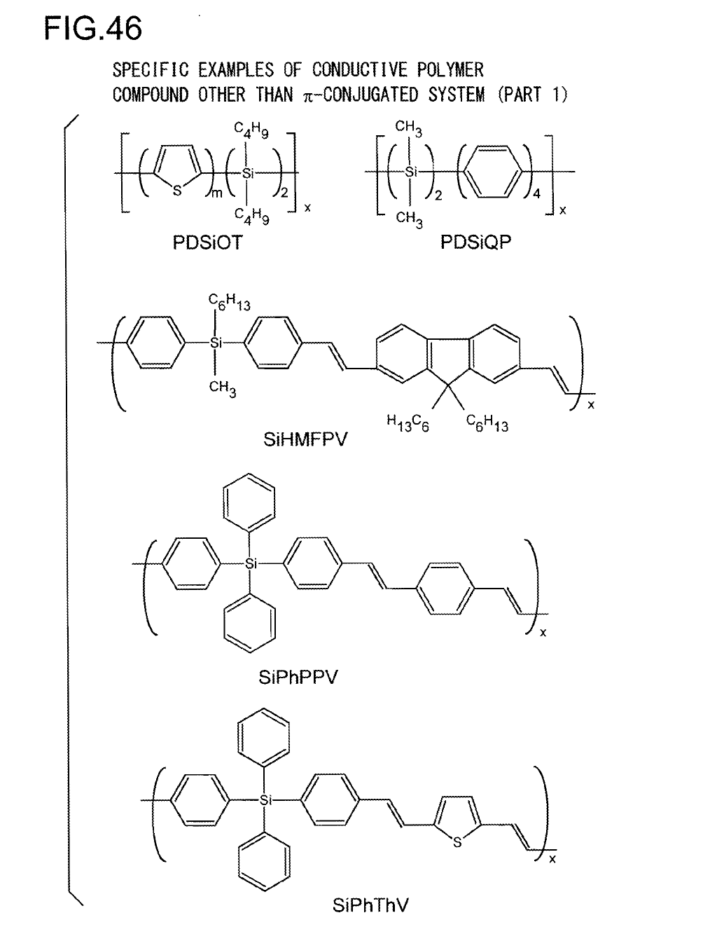

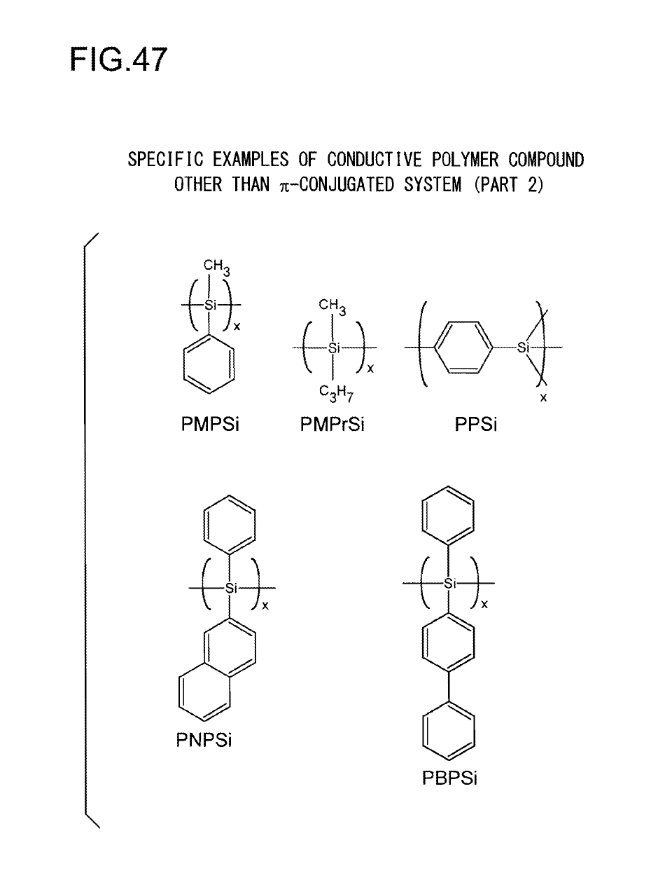

Examples of the light-emitting material used in the low-molecular organic EL element include compounds described in pages 36 to 56 of the book entitled “Organic EL Elements and its Frontier of Industrialization (published on Nov. 30, 1998 by NTS Company Ltd.)” and compounds described in pages 148 to 172 of the book entitled “Organic EL Material and Display (published on Feb. 28, 2001 by CAC Company Ltd.).” In the tenth embodiment, the conductive polymer compound is particularly preferable as the organic compound capable of photoelectric conversion, and the π-conjugated polymer compound is most preferable. FIG. 41 shows basic skeletons of the conductive polymer compound; FIGS. 42 to 45 show specific examples of the π-conjugated polymer compound; and FIGS. 46 and 47 show specific examples of the conductive polymer compound other than the π-conjugated polymer compound. The conductive polymer material and the low-molecular organic EL element are not limited to those described above.

For example, the hole block layer 322 can be formed of PEDOT/PSS (poly(3,4-ethylenedioxythiophene)/polystyrene sulphonic acid), polyaniline or the like. The electron block layer 324 can be formed of BCP, Alq3, BAIq, C60, LiF, TiOx or the like.

In order to improve the efficiency of conversion into the photoelectric conversion layer 323 and the transfer of carriers to the electrode, the hole block layer 322 and the electron block layer 324 may be formed by adding an additive and providing as a separate layer the portion to which the additive is added.

As the additive described above, a hole injection material, a hole transport material, an electron transport material, an electron injection material or the like used in the organic EL element can be applied. Its specific examples include: a triazole derivative; an oxadiazole derivative; an imidazole derivative; a polyarylalkane derivative; a pyrazoline derivative or pyrazolone derivative; a phenylenediamine derivative; an arylamine derivative; an amino-substituted chalcone derivative; an oxazole derivative; a styrylanthracene derivative; a fluorenone derivative; a hydrazone derivative; a stilbene derivative; a silazane derivative; an aniline copolymer or a conductive polymer oligomer, especially a thiophene oligomer; a porphyrin compound; an aromatic tertiary amine compound or a styrylamine compound; a nitro-substituted fluorene derivative; a diphenylquinone derivative; a thiopyran dioxide derivative; a heterocyclic tetracarboxylic anhydride such as a naphthalene perylene; a carbodiimide; a fluoreneylidene methane derivative; anthraquinodimethane or an anthrone derivative; an oxadiazole derivative; a thiadiazole derivative; a quinoxaline derivative; and a metal complex of an 8-quinolinol derivative (such as tris(8-quinolinolate)aluminum (Alq3), tris(5,7-dichloro-8-quinolinolate)aluminum, tris(5,7-dibromo-8-quinolinolate)aluminum, tris(2-methyl-8-quinolinolate)aluminum, tris(5-methyl-8-quinolinolate)aluminum, bis(8-quinolinolate)zinc (Znq2)).

In order to exchange carriers between a plurality of π-conjugated polymer compounds or trap carriers, it is preferable to add a compound having a three-dimensional π-electron cloud such as fullerene or carbon nanotube to the hole block layer 322, the photoelectric conversion layer 323 and the electron block layer 324, which use a π-conjugated polymer compound.

Examples of the compound include: fullerene C-60; fullerene C-70; fullerene C-76; fullerene C-78; fullerene C-84; fullerene C-240; fullerene C-540; mixed fullerene; fullerene nanotube; multi-walled nanotube; and single-walled nanotube. A substituted group may be introduced into fullerene or carbon nanotube in order to provide compatibility with solvent.

In the organic semiconductor layer 315 of the organic TFT 310, pentacene or the like, for example, can be used as a constituent material. Moreover, as a constituent material of the organic semiconductor layer 315, an organic semiconductor material that can be dissolved or dispersed in a solvent can be used. For example, as the constituent material, any of the following materials can be used: polythiophenes such as poly(3-hexylthiophene); aromatic oligomers, such as oligothiophene, that have a side chain based on a thiophene hexamer; pentacenes obtained by providing a substituted group for pentacen to enhance solubility; a copolymer (F8T2) between polyfluorene and thiophene; polythienylene vinylene; phthalocyanine; and the like. When, as described above, the organic semiconductor layer 315 is formed of an organic semiconductor material that can be dissolved or dispersed in a solvent, it is possible to easily form the organic semiconductor layer 315 (organic TFT 310) by a printing process.

The compound of which the organic semiconductor layer 315 is formed may be single-crystal or amorphous, and it may have a low-molecular weight or a high-molecular weight. Examples of a particularly preferable compound include: the single crystal of a condensed-ring aromatic hydrocarbon compound such as pentacene, triphenylene or anthracene; and the π-conjugated polymer.

In the organic TFT 310, the source electrode 313, the drain electrode 314 and the gate electrode 311 may be formed of any of a metal, a conductive inorganic compound and a conductive organic compound; the conductive organic compound is preferable in terms of ease of production. A typical example thereof is a compound obtained by doping the π-conjugated polymer compound with a Lewis acid (such as ferric chloride, aluminum chloride or antimony bromide), a halogen (such as iodine or bromine) or a sulfonate (such as a sodium salt of a polystyrene sulfonate (PSS) or p-toluenesulfonic acid potassium salt). Specifically, a conductive polymer obtained by adding PSS to PEDOT is taken as a typical example.

The other parts of the configuration of the image input/output device according to the tenth embodiment are the same as in the first to fifth embodiments.

In the image input/output device of the tenth embodiment, since, as described above, the organic TFT 310 and the photoelectric conversion portion 320 are formed of organic semiconductor, and thus printing technology and inkjet technology can be utilized, facilities such as a vacuum deposition device necessary to form the organic TFT 310 and the photoelectric conversion portion 320 with inorganic semiconductor are unnecessary. Thus, it is possible to easily form the organic TFT 310 and the photoelectric conversion portion 320 and easily manufacture them at a low cost. In this way, it is possible to easily manufacture an image input/output device that can instantaneously write an image by applying an optical pattern and that can acquire information on the written image as image data. It is also possible to reduce the manufacturing cost of the image input/output device.

In the tenth embodiment, since the above configuration allows printing technology and inkjet technology to be utilized, it is possible to reduce processing temperature. Thus, it is possible to form the organic TFT 310 and the photoelectric conversion portion 320 even on a heat-sensitive plastic substrate. In other words, a resin substrate formed with a plastic film or the like can be used as the substrate 301. It is therefore possible to obtain an image input/output device that is lightweight and thin and that can be bent. It is also possible to improve shock resistance.

Examples of the plastic film include films that are formed of polyethylene terephthalate (PET), polyethylene naphthalate (PEN), polyether sulfone (PES), polyetherimide, polyether ether ketone, polyphenylene sulfide, polyarylate, polyimide, polycarbonate (PC), cellulose triacetate (TAC), cellulose acetate propionate (CAP) and the like.

A plasticizer such as trioctyl phosphate or dibutyl phthalate may be further added to these plastic films; a known ultraviolet absorbing agent such as a benzotriazole ultraviolet absorbing agent or a benzophenone ultraviolet absorbing agent may be added thereto. It is also possible to use, as a raw material, a resin produced by a so-called organic-inorganic polymer hybrid method in which an inorganic polymer raw material such as tetraethoxysilane is added and in which a chemical catalyst and energy such as heat and light are provided to achieve high molecular weight.

The other effects of the image input/output device according to the tenth embodiment are the same as in the first to fifth embodiments.

The embodiments disclosed herein should be considered to be illustrative in all respects and not restrictive. The scope of the present invention is indicated not by the description of the above embodiments but by the scope of claims, and meaning equivalent to the scope of claims and all modifications falling within the scope of claims are included.

For example, although the first to tenth embodiments deal with a case where exposure is performed with the display layer of the display portion substantially in the transparent state and thus an image is displayed on the display portion, the present invention is not limited to this case. As long as the writing light is not transmitted through the display layer and is received by the photoelectric conversion portion, it is unnecessary that the display layer be substantially in the transparent state at the time of exposure.

Although the first to tenth embodiments deal with a case where the TFT, the photoelectric conversion portion and the display portion are formed on one substrate, the present invention is not limited to this case. The TFT, the photoelectric conversion portion and the display portion may be formed on different substrates. For example, the TFT and the photoelectric conversion portion are formed on the same substrate, and the display portion is formed using a substrate different from the substrate on which the switching element and the photoelectric conversion portion are formed. By doing so, the display portion may be separated from the TFT and the photoelectric conversion potion.

Although the first to tenth embodiments deal with a case where the pixel electrode and the common electrode are formed of ITO, the present invention is not limited to this case. The pixel electrode and the common electrode may be formed of a transparent conductive material other than ITO. For example, the pixel electrode and the common electrode may be formed of IZO (registered trademark). One (electrode unnecessary to be transparent) of the pixel electrode and the common electrode may be formed of an opaque electrode material. Examples of the opaque electrode material include Au, Ag, Cu, Pt, Pd, Fe, Ni, carbon, Ce, Al, Mo, and their deposited films and their alloys.

Although the first to tenth embodiments deal with a case where the pixel array portion is formed with the substrate (the first substrate, the second substrate) having optical transparency, the present invention is not limited to this case. At least one of the substrates constituting the pixel array portion may have no optical transparency. In other words, the substrate on the observation side and the substrate on the exposure side should have optical transparency. For example, when the image input/output device is configured such that exposure is performed from the same side as the observation side, it is possible to use a substrate having no optical transparency as the substrate on the opposite side to the observation side. In this case, a substrate having visible light absorbency is used, and thus the light absorbent layer may be omitted.

In the first to tenth embodiments, the reference voltage V_{REF} and the voltage V_{E} of the direct-current voltage source can be set as appropriate to achieve a desired operation.

In the first to tenth embodiments, the second substrate may be omitted.

In the first to tenth embodiments, any display portion other than the display portion described above may be used as long as the display state of the display portion can be changed by applying a voltage.

Although the first to ninth embodiments deal with a case where the TFT is configured in the bottom-gate/top-contact structure, the present invention is not limited to this case. The TFT may be configured in a structure other than the bottom-gate/top-contact structure. For example, the TFT may be configured in a top-gate structure. Alternatively, the TFT may be configured in a bottom-gate/bottom-contact structure.

Although the first to fourth embodiments (and the sixth to tenth embodiments) deal with a case where the display portion (display element) is provided with the insulation thin film, the present invention is not limited to this case. In the display portion (display element), the insulation thin film may be omitted. In order to prevent a short circuit between the electrodes and enhance the reliability of gas barrier properties of a liquid crystal display element, it is preferable to form an insulation thin film on at least one side of the display pixel electrode and the display common electrode.

Although the first to fourth embodiments (and the sixth to tenth embodiments) deal with a case where the display portion (display element) is provided with the alignment film, the present invention is not limited to this case. In the display portion (display element), the alignment film may be omitted. The alignment film is preferably provided to achieve the stability of the element and the like. Preferably, when the alignment film is formed, if the insulation thin film is formed on the electrode, the alignment film is formed on the insulation thin film whereas, if the insulation thin film is not formed on the electrode, the alignment film is formed on the electrode. The alignment film can be formed of any of the following materials other than those described in the above embodiments: for example, polyimide resin; silicone resin; polyamide-imide resin; polyetherimide resin; polyvinyl butyral resin; and acrylic resin. The alignment film can be formed by a printing method or the like. The alignment film formed of any of these materials may be subjected to rubbing processing. The alignment film can also be formed of the same material as the high polymer resin used in the polymer structure.

Although the first to fourth embodiments (and the sixth to tenth embodiments) deal with a case where the spacer (Micropearl, 5.0 μm) produced by Sekisui Fine Chemical Co. Ltd. is used, a component other than the above component may be used as a spacer.

In the first to fourth embodiments (and the sixth to tenth embodiments), the polymer structure placed in the display portion (display element) may be formed in any shape such as a cylindrical shape, an elliptic cylindrical shape or a quadrangular prism shape; the polymer structures may be arranged randomly or arranged regularly, for example, in a grid pattern. The provision of the polymer structures in the display portion (display element) makes it easy to maintain a constant space between the substrates (cell gap) and makes it possible to enhance the self-maintenance of the display element itself. In particular, when dot-shaped polymer structures are spaced regularly, uniform display performance is easily achieved. The height of the polymer structure corresponds to the thickness of the cell gap, that is, the thickness of the display layer formed of the liquid crystal composition. When flexible resin substrates are used as the substrates that sandwich the display layer, it is particularly effective to provide the polymer structures. This is because the flexibility of the substrates prevents the thickness of the display layer from becoming uneven.

The polymer structure can be formed by so-called photolithography, in which a light curable resin material such as a photoresist material formed of an ultraviolet curable monomer is used and applied to the outermost surface film (the insulation thin film, the alignment film) of the substrate such that its desired thickness is achieved, and in which pattern exposure is performed such as by applying ultraviolet rays to this coating through a mask to remove an uncured portion. Alternatively, a resin material or the like obtained by dissolving a thermoplastic resin in an appropriate solvent may be used to form a polymer structure made of the thermoplastic resin. In this case, the polymer structure can be formed by any of the following methods: a printing method in which printing is performed on a substrate by using a screen, a metal mask and the like and pushing out a thermoplastic resin material with a squeegee; a dispenser method, an inkjet method or the like in which the polymer structure is formed by discharging resin material through the tip of a nozzle onto a substrate; a transfer method in which a resin material is supplied onto a flat plate or a roller and is then transferred to the surface of the substrate; and other methods.

At least one of a spacer and a columnar structure may be formed on the display portion (display element).

Although the first to fourth embodiments (and the sixth to tenth embodiments) deal with a case where the cell gap of the pixel array portion is set at about 5 μm, the present invention is not limited to this case. The cell gap may be set at a value other than the above value. The cell gap may be set at 2 to 50 μm; it is preferably set at 3 to 15 μm. The cell gap is set within the desired range, and thus it is possible to effectively obtain the effect of achieving high contrast even with a relatively low applied voltage.

Although the first to third embodiments (and the sixth to tenth embodiments) deal with a case where the nematic liquid crystal (BL006) produced by Merck & Co. is used as the nematic liquid crystal composition for the display layer, the present invention is not limited to this nematic liquid crystal. A nematic liquid crystal that is conventionally known in the field of liquid crystal display elements can be used. Examples of the nematic liquid crystal material include a liquid-crystalline ester compound, a liquid-crystalline pyrimidine compound, a liquid-crystalline cyanobiphenyl compound, a liquid-crystalline tolan compound, a liquid-crystalline phenylcyclohexane compound, a liquid-crystalline terphenyl compound and fluorine atoms, other liquid crystal compounds having polar groups such as a polyfluoroalkyl group and a cyano group; and their mixtures.

Although the fourth embodiment deals with a case where the chiral nematic liquid crystal is obtained by mixing the nematic liquid crystal (BL006; produced by Merck & Co.) with the chiral agent (CB15; produced by Merck & Co., Inc.), a chiral nematic liquid crystal may be produced using a nematic liquid crystal and a chiral agent other than the above nematic liquid crystal and chiral agent as long as a desired characteristic can be acquired. The present invention is not limited to this nematic liquid crystal; a nematic liquid crystal that is conventionally known in the field of liquid crystal display elements can be used. Examples of the nematic liquid crystal material include a liquid-crystalline ester compound, a liquid-crystalline pyrimidine compound, a liquid-crystalline cyanobiphenyl compound, a liquid-crystalline tolan compound, a liquid-crystalline phenylcyclohexane compound, a liquid-crystalline terphenyl compound and fluorine atoms, other liquid crystal compounds having polar groups such as a polyfluoroalkyl group and a cyano group; and their mixtures. Any of various chiral agents that are conventionally known in the field of liquid crystal display elements can be used as the above chiral agent. Examples of the chiral agent include: a cholesteric compound having a cholesteric ring; a biphenyl compound having a biphenyl skeleton; a terphenyl compound having a terphenyl skeleton; an ester compound having a skeleton in which two benzene rings are linked by ester bonding; a cyclohexane compound having a skeleton in which a cyclohexane ring is directly linked to a benzene ring; a pyrimidine compound having a skeleton in which a pyrimidine ring is directly linked to a benzene ring; and an azoxy compound having a skeleton in which two benzene rings are linked by azoxy bonding or axo bonding.

Although the fifth embodiment (and the sixth to tenth embodiments) deal with a case where the display layer formed with the electrolyte layer is formed of an electrolytic solution containing silver iodide, the present invention is not limited to this case. As the electrolyte layer, any electrolyte layer may be used as long as it has silver or a compound containing silver in its chemical structure. The silver or the compound containing silver in its chemical structure refers to a generic name for a compound such as silver oxide, silver sulfide, metallic silver, silver colloid particles, a silver halide, a silver complex compound and silver ions. The type of phase state such as a solid state, a liquid-soluble state or a gas state and the type of charge state such as a neutral state, an anionic state or a cationic state are not particularly considered here.

Although the fifth embodiment (and the sixth to tenth embodiments) deal with, as an example of the electrochemical reaction display element, the ECD element utilizing the color change of an electrochromic material resulting from an oxidation-reduction reaction, the present invention is not limited to this element. As the electrochemical reaction display element, an electrodeposition (ED) display element utilizing the dissolution and precipitation of a metal or a metallic salt may be used.

The configuration and the like of the substrate, the photoelectric conversion layer and the display layer deposited that are described in the eighth to tenth embodiments may be the same as in the sixth embodiment (including the variations) or the seventh embodiment (including the variations).

Although the tenth embodiment deals with a case where the organic TFT is configured by sequentially forming on the substrate the gate electrode, the insulation layer, the source electrode/the drain electrode and the organic semiconductor layer, the present invention is not limited to this configuration. The organic TFT may be configured by sequentially forming on the substrate the gate electrode, the insulation layer, the organic semiconductor layer and the source electrode/the drain electrode. The organic TFT may be configured by sequentially forming, on an organic semiconductor single crystal, the source electrode/the drain electrode, the insulation layer and the gate electrode. The organic TFT may be configured using any of organic semiconductors disclosed in journals such as Science 283 and 822 (1999), Applied Physics Letters 771488 (1998) and Nature 403 and 521 (2000).

Although the tenth embodiment deals with a case where the photoelectric conversion portion is provided with the hole block layer and the electron block layer, the present invention is not limited to this configuration. The hole block layer and the electron block layer may be omitted.

Although the tenth embodiment deals with a case where the capacitor for storing electrical energy is provided on the side of the lower layer of the photoelectric conversion portion of the pixel array portion, the present invention is not limited to this configuration. The capacitor may be omitted.

Although the tenth embodiment deals with a case where the organic TFT and the photoelectric conversion portion are configured in a bias top structure, the present invention is not limited to this configuration. The organic TFT and the photoelectric conversion portion may be configured either in a bias bottom structure or in a stack structure.

### LIST OF REFERENCE SYMBOLS

1 First substrate (substrate)
2 Light absorbent layer
3 Second substrate
10 TFT (switching element)
11 Gate wiring layer, Scanning line
11a Gate electrode
   13 Semiconductor layer
   14 Ohmic contact layer
   15 Source electrode
   16 Drain electrode
   20 Photoelectric conversion portion
   21 Photoelectric conversion layer
   22 Photoelectric conversion pixel electrode (second pixel electrode)
   23 Photoelectric conversion pixel electrode (second pixel electrode)
   30 Display portion, Display element
   31 Display pixel electrode (first pixel electrode)
   32 Display common electrode (first common electrode)
   33 Display layer
   40 Direct-current voltage source
   50 Pixel array portion
   50a Pixel
   55 Array substrate
   56 Opposite substrate
   60 Scanning drive circuit
   70 Column output circuit
   71 Charge sensing amplifier (amplifier portion)
   74, 75 Sample and hold circuit
   80 Multiplexer
   90 A-D converter
   100 Timing generator
   110 Memory (recording portion)
   202 Light reflective layer
   212 Semi-absorbent, semi-transmissive layer
   222 Semi-reflective, semi-transmissive layer
   301 Substrate
   303 Planarization film
   310 Organic TFT (switching element)
   311 Gate electrode
   312 Insulation layer
   313 Source electrode
   314 Drain electrode
   315 Organic semiconductor layer
   320 Photoelectric conversion portion
   322 Hole block layer
   323 Photoelectric conversion layer
   324 Electron block layer

1. An image input/output device comprising:
a switching element formed on a substrate;
a display portion that is formed on the substrate and that includes a display layer and a first pixel electrode and a first common electrode, the first pixel electrode and the first common electrode sandwiching the display layer;
a photoelectric conversion portion that is formed on the substrate and that includes a photoelectric conversion layer and a second pixel electrode and a second common electrode, the second pixel electrode and the second common electrode sandwiching the photoelectric conversion layer; and
an amplification portion that amplifies an output signal from the photoelectric conversion portion,
wherein the first pixel electrode of the display portion and the second pixel electrode of the photoelectric conversion portion are electrically connected to each other,
the switching element can switch, between an “on” state and an “off” state, a connection between the first pixel electrode and the second pixel electrode electrically connected to each other and the amplification portion, and
the first common electrode can switch between a constant potential state and a floated state.

2. The image input/output device of claim 1,
wherein an image corresponding to an exposure pattern is displayed on the display portion by exposure.

3. The image input/output device of claim 1,
wherein the first common electrode is brought into the constant potential state such that the display layer of the display portion is brought into a substantially transmissive state, and
exposure is performed with the display layer in the substantially transmissive state such that an image corresponding to an exposure pattern is displayed on the display portion.

4. The image input/output device of claim 2,
wherein the first common electrode and the switching element are brought into the floated state and the “on” state, respectively, after the exposure such that information on the image displayed on the display portion is acquired as image data.

5. The image input/output device of claim 4, further comprising:
a recording portion that records the acquired image data.

6. The image input/output device of claim 1,
wherein a predetermined potential is applied to the photoelectric conversion portion to reset the photoelectric conversion portion, and
a difference between a potential applied to the first common electrode and an applied potential for resetting the photoelectric conversion portion is less than a potential difference that is necessary to turn a display state of the display portion from an “on” state to an “off” state.

7. The image input/output device of claim 1,
wherein a predetermined potential is applied to the photoelectric conversion portion to reset the photoelectric conversion portion, and
a difference between a potential applied to the first common electrode and an applied potential for resetting the photoelectric conversion portion is equal to or more than a potential difference that is necessary to turn a display state of the display portion from an “on” state to an “off” state.

8. The image input/output device of claim 1,
wherein any one of a light absorbent layer, a light reflective layer, a semi-absorbent, semi-transmissive layer and a semi-reflective, semi-transmissive layer is included, and
when seen from an observation side, any one of the light absorbent layer, the light reflective layer, the semi-absorbent, semi-transmissive layer and the semi-reflective, semi-transmissive layer is formed on a side of a back surface of the display layer of the display portion.

9. The image input/output device of claim 1,
wherein the display portion includes a display element having a memory characteristic.

10. The image input/output device of claim 9,
wherein the display element having a memory characteristic includes chiral nematic liquid crystal.

11. The image input/output device of claim 9,
wherein the display element having a memory characteristic is an electrochemical reaction display element.

12. The image input/output device of claim 1,
wherein the photoelectric conversion layer and the display layer are sequentially formed on the substrate from a side of the substrate.

13. The image input/output device of claim 1,
wherein the display layer and the photoelectric conversion layer are sequentially formed on the substrate from the side of the substrate.

14. The image input/output device of claim 1,
wherein the image corresponding to the exposure pattern is displayed on the display portion by performing the exposure from a side of a back surface of the substrate.

15. The image input/output device of claim 1,
wherein the image corresponding to the exposure pattern is displayed on the display portion by performing the exposure from a side of a front surface of the substrate.

16. The image input/output device of claim 1,
wherein the switching element is formed with a thin film transistor element.

17. The image input/output device of claim 16,
wherein the second pixel electrode is arranged on a side of the substrate with respect to the photoelectric conversion layer and the second common electrode is arranged on a side opposite the substrate with respect to the photoelectric conversion layer such that the thin film transistor element and the photoelectric conversion portion are configured in a bias top structure.

18. The image input/output device of claim 16,
wherein the second pixel electrode is arranged on a side opposite the substrate with respect to the photoelectric conversion layer and the second common electrode is arranged on a side of the substrate with respect to the photoelectric conversion layer such that the thin film transistor element and the photoelectric conversion portion are configured in a bias bottom structure.

19. The image input/output device of claim 16,
wherein the photoelectric conversion portion is formed above the thin film transistor element such that the thin film transistor element and the photoelectric conversion portion are configured in a stack structure.

20. The image input/output device of claim 16,
wherein at least one of the thin film transistor element and the photoelectric conversion layer is formed of organic semiconductor.

21. The image input/output device of claim 1,
wherein the amplification portion is a charge sensing amplifier including an operational amplifier and a capacitor.
